(19) United States
(12) Patent Application Publication
(10) Pub. No.: US 2020/0068416 A1
(43) Pub. Date: Feb. 27, 2020

(54) METHOD FOR PERFORMING BEAM RECOVERY IN WIRELESS COMMUNICATION SYSTEM AND APPARATUS THEREFOR

(71) Applicant: LG Electronics Inc., Seoul (KR)

(72) Inventors: Jiwon KANG, Seoul (KR); Minki AHN, Seoul (KR); Kilbom LEE, Seoul (KR)

(21) Appl. No.: 16/610,800

(22) PCT Filed: May 4, 2018
(86) PCT No.: PCT/KR2018/005192

§ 371 Date: Nov. 4, 2019

Related U.S. Application Data
(60) Provisional application No. 62/501,185, filed on May 4, 2017.

(51) Int. Cl. H04W 16/28; H04L 5/00; H04W 72/04; H04W 74/08

(52) U.S. Cl. CPC H04W 16/28; H04L 5/0048; H04W 74/0833; H04W 72/0413; H04W 72/046

(57) ABSTRACT

The specification provides a method for beam recovery in a wireless communication system. In the present disclosure, a method for beam recovery, performed by a terminal, comprises the steps of: receiving a beam reference signal used for beam management from a base station; determining an uplink (UL) resource for transmitting a control signal associated with a beam failure recovery request when a beam failure event is detected, wherein the UL resource is type 1 resource indicating a resource associated with a physical random access channel (PRACH) configured for the beam failure recovery request or type 2 resource indicating a physical uplink control channel (PUCCH) resource; and transmitting the control signal to the base station in the determined UL resource.

### TECHNICAL FIELD

The present disclosure relates to a wireless communication system, and more particularly, to a method for performing beam recovery and an apparatus supporting the same.

### BACKGROUND ART

Mobile communication systems have been generally developed to provide voice services while guaranteeing user mobility. Such mobile communication systems have gradually expanded their coverage from voice services through data services up to high-speed data services. However, as current mobile communication systems suffer resource shortages and users demand even higher-speed services, development of more advanced mobile communication systems is needed.

The requirements of the next-generation mobile communication system may include supporting huge data traffic, a remarkable increase in the transfer rate of each user, the accommodation of a significantly increased number of connection devices, very low end-to-end latency, and high energy efficiency. To this end, various techniques, such as small cell enhancement, dual connectivity, massive multiple input multiple output (MIMO), in-band full duplex, non-orthogonal multiple access (NOMA), supporting super-wide band, and device networking, have been researched.

### DISCLOSURE

### Technical Problem

An embodiment of the present disclosure provides a method for transmitting some or all of beam report information together according to a type of UL resource when a beam recovery request (or beam failure report) is performed.

Technical objects to be achieved by the present invention are not limited to the aforementioned technical objects, and other technical objects not described above may be evidently understood by a person having ordinary skill in the art to which the present invention pertains from the following description.

### Technical Solution

In the present disclosure, a method for performing beam recovery in a wireless communication system, which is performed by a user equipment (UE), includes: receiving, from a base station (BS), a beam reference signal used for beam management; determining an uplink (UL) resource for transmitting a control signal related to a beam failure recovery request if a beam failure event is detected, wherein the UL resource is type 1 indicating a resource related to a physical random access channel (PRACH) set for the beam failure recovery request or type 2 indicating a physical uplink control channel (PUCCH) resource; and transmitting, to the BS, the control signal in the determined UL resource, wherein the control signal includes some or all of information related to beam reporting.

In the present disclosure, the PUCCH resource may be at least one of a short PUCCH or a long PUCCH.

Furthermore, in the present disclosure, when the UL resource is a type 2 resource, the control signal may include all of the information related to the beam reporting.

Furthermore, in the present disclosure, the information related to the beam reporting may include at least one of beam identification information for beam identification or beam quality information indicating beam quality.

Furthermore, in the present disclosure, the type 1 may be frequency division multiplexing (FDM)-ed and/or code division multiplexing (CDM)-ed with the PRACH.

Furthermore, in the present disclosure, when the UL resource is type 1 resource, the control signal may include only part of the information related to the beam reporting.

Furthermore, in the present disclosure, the information related to the beam reporting may include information on the presence or absence of an alternative beam.

Furthermore, in the present disclosure, the alternative beam may be a reference signal having a channel quality greater than a specific channel quality among reference signals set for the beam management.

The method may further include: reporting a beam measurement result to the BS in a specific resource when the control signal includes part of information related to the beam reporting.

Furthermore, in the present disclosure, when beam reporting is triggered, the beam measurement result may be reported.

In the present disclosure, a user equipment (UE) for performing beam recovery in a wireless communication system, includes: a radio frequency (RF) module transmitting and receiving a wireless signal; and a processor functionally connected to the RF module, wherein the processor receives, from a base station (BS), a beam reference signal used for beam management and determines an uplink (UL) resource for transmitting a control signal related to a beam failure recovery request if a beam failure event is detected, wherein the UL resource is type 1 indicating a resource related to a physical random access channel (PRACH) set for the beam failure recovery request or type 2 indicating a physical uplink control channel (PUCCH) resource, and the processor transmits, to the BS, the control signal in the determined UL resource, wherein the control signal includes some or all of information related to beam reporting.

### Advantageous Effects

The present disclosure has an advantage in that, when a beam recovery request is made, some or all of the beam report information is reported together, thereby reducing a time for the beam recovery process.

Furthermore, the present disclosure has an advantage in that the amount of information related to beam reporting may be flexibly adjusted according to a type of a UL resource.

It will be appreciated by persons skilled in the art that that the effects that could be achieved with the present invention are not limited to what has been particularly described hereinabove and other advantages of the present invention will be more clearly understood by a person skilled in the art to which the present invention pertains, from the following detailed description.

### DESCRIPTION OF DRAWINGS

The accompanying drawings, which are included to provide a further understanding of the invention, illustrate embodiments of the invention and together with the description serve to explain the principle of the disclosure.

FIG. 1 is a diagram showing an example of an overall system structure of NR to which a method proposed in the present disclosure may be applied.

FIG. 2 shows a relationship between an uplink frame and a downlink frame in a wireless communication system to which a method proposed in the present disclosure may be applied.

FIG. 3 shows an example of a resource grid supported in a wireless communication system to which a method proposed in the present disclosure may be applied.

FIG. 4 shows examples of resource grids for each antenna port and each numerology to which a method proposed in the present disclosure may be applied.

FIG. 5 shows an example of a block diagram of a transmitter including an analog beamformer and an RF chain.

FIG. 6 shows an example of a block diagram of a transmitter including a digital beamformer and an RF chain.

FIG. 7 shows an example of an analog beam scanning method.

FIG. 8 shows an example of a PUSCH CSI report mode.

FIG. 9 shows an example of a PUCCH CSI report mode.

FIG. 10 shows an example of a network operation according to the presence or absence of an alternative beam.

FIG. 11 shows an example of a beam-related setting method.

FIG. 12 is a flowchart illustrating an example of a method of performing beam recovery.

FIG. 13 is a flowchart illustrating an example of an operation of a user equipment (UE) that performs beam recovery proposed in the present disclosure.

FIG. 14 is a flowchart illustrating another example of an operation of a UE that performs beam recovery according to the present disclosure.

FIG. 15 is a block diagram of a wireless communication device according to an embodiment of the present disclosure.

FIG. 16 is a block diagram of a communication device according to an embodiment of the present disclosure.

FIG. 17 is a view showing an example of an RF module of a wireless communication device to which a method proposed in the present disclosure may be applied.

FIG. 18 is a view showing still another example of an RF module of a wireless communication device to which a method proposed in the present disclosure may be applied.

### MODE FOR INVENTION

Some embodiments of the present disclosure are described in detail with reference to the accompanying drawings. A detailed description to be disclosed along with the accompanying drawings is intended to describe some exemplary embodiments of the present disclosure and is not intended to describe a sole embodiment of the present disclosure. The following detailed description includes more details in order to provide full understanding of the present disclosure. However, those skilled in the art will understand that the present disclosure may be implemented without such more details.

In some cases, in order to avoid making the concept of the present disclosure vague, known structures and devices are omitted or may be shown in a block diagram form based on the core functions of each structure and device.

In the present disclosure, a base station has the meaning of a terminal node of a network over which the base station directly communicates with a terminal. In this document, a specific operation that is described to be performed by a base station may be performed by an upper node of the base station according to circumstances. That is, it is evident that in a network including a plurality of network nodes including a base station, various operations performed for communication with a terminal may be performed by the base station or other network nodes other than the base station. The base station (BS) may be substituted with another term, such as a fixed station, a Node B, an eNB (evolved-NodeB), a base transceiver system (BTS), or an access point (AP). Furthermore, the terminal may be fixed or may have mobility and may be substituted with another term, such as user equipment (UE), a mobile station (MS), a user terminal (UT), a mobile subscriber station (MSS), a subscriber station (SS), an advanced mobile station (AMS), a wireless terminal (WT), a machine-type communication (MTC) device, a machine-to-Machine (M2M) device, or a device-to-device (D2D) device.

Hereinafter, downlink (DL) means communication from a base station to UE, and uplink (UL) means communication from UE to a base station. In DL, a transmitter may be part of a base station, and a receiver may be part of UE. In UL, a transmitter may be part of UE, and a receiver may be part of a base station.

Specific terms used in the following description have been provided to help understanding of the present disclosure, and the use of such specific terms may be changed in various forms without departing from the technical sprit of the present disclosure.

The following technologies may be used in a variety of wireless communication systems, such as code division multiple access (CDMA), frequency division multiple access (FDMA), time division multiple access (TDMA), orthogonal frequency division multiple access (OFDMA), single carrier frequency division multiple access (SC-FDMA), and non-orthogonal multiple access (NOMA). CDMA may be implemented using a radio technology, such as universal terrestrial radio access (UTRA) or CDMA2000. TDMA may be implemented using a radio technology, such as global system for mobile communications (GSM)/general packet radio service (GPRS)/enhanced data rates for GSM evolution (EDGE). OFDMA may be implemented using a radio technology, such as Institute of electrical and electronics engineers (IEEE) 802.11 (Wi-Fi), IEEE 802.16 (WiMAX), IEEE 802.20, or evolved UTRA (E-UTRA). UTRA is part of a universal mobile telecommunications system (UMTS). 3rd generation partnership project (3GPP) Long term evolution (LTE) is part of an evolved UMTS (E-UMTS) using evolved UMTS terrestrial radio access (E-UTRA), and it adopts OFDMA in downlink and adopts SC-FDMA in uplink. LTE-advanced (LTE-A) is the evolution of 3GPP LTE.

Embodiments of the present disclosure may be supported by the standard documents disclosed in at least one of IEEE 802, 3GPP, and 3GPP2, that is, radio access systems. That is, steps or portions that belong to the embodiments of the present disclosure and that are not described in order to clearly expose the technical spirit of the present disclosure may be supported by the documents. Furthermore, all terms disclosed in this document may be described by the standard documents.

In order to more clarify a description, 3GPP LTE/LTE-A is chiefly described, but the technical characteristics of the present disclosure are not limited thereto.

### Definition of Terms

eLTE eNB: An eLTE eNB is an evolution of an eNB that supports a connection for an EPC and an NGC.

gNB: A node for supporting NR in addition to a connection with an NGC

New RAN: A radio access network that supports NR or E-UTRA or interacts with an NGC

Network slice: A network slice is a network defined by an operator so as to provide a solution optimized for a specific market scenario that requires a specific requirement together with an inter-terminal range.

Network function: A network function is a logical node in a network infra that has a well-defined external interface and a well-defined functional operation.

NG-C: A control plane interface used for NG2 reference point between new RAN and an NGC

NG-U: A user plane interface used for NG3 reference point between new RAN and an NGC

Non-standalone NR: A deployment configuration in which a gNB requires an LTE eNB as an anchor for a control plane connection to an EPC or requires an eLTE eNB as an anchor for a control plane connection to an NGC

Non-standalone E-UTRA: A deployment configuration an eLTE eNB requires a gNB as an anchor for a control plane connection to an NGC.

User plane gateway: A terminal point of NG-U interface

General System

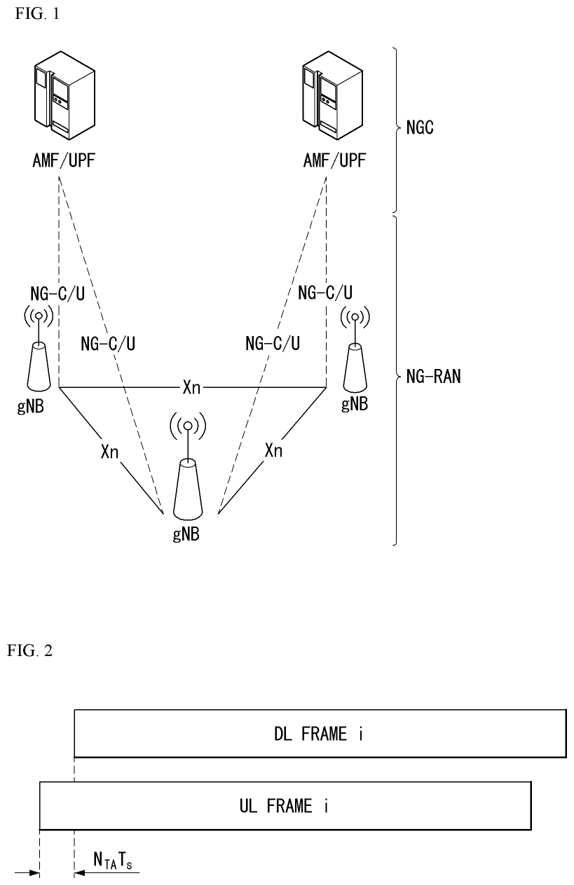

FIG. 1 is a diagram illustrating an example of an overall structure of a new radio (NR) system to which a method proposed by the present disclosure may be implemented.

Referring to FIG. 1, an NG-RAN is composed of gNBs that provide an NG-RA user plane (new AS sublayer/PDCP/RLC/MAC/PHY) and a control plane (RRC) protocol terminal for a UE (User Equipment).

The gNBs are connected to each other via an Xn interface.

The gNBs are also connected to an NGC via an NG interface.

More specifically, the gNBs are connected to a Access and Mobility Management Function (AMF) via an N2 interface and a User Plane Function (UPF) via an N3 interface.

NR (New Rat) Numerology and Frame Structure

In the NR system, multiple numerologies may be supported. The numerologies may be defined by subcarrier spacing and a CP (Cyclic Prefix) overhead. Spacing between the plurality of subcarriers may be derived by scaling basic subcarrier spacing into an integer N (or μ). In addition, although a very low subcarrier spacing is assumed not to be used at a very high subcarrier frequency, a numerology to be used may be selected independent of a frequency band.

In addition, in the NR system, a variety of frame structures according to the multiple numerologies may be supported.

Hereinafter, an Orthogonal Frequency Division Multiplexing (OFDM) numerology and a frame structure, which may be considered in the NR system, will be described.

A plurality of OFDM numerologies supported in the NR system may be defined as in Table 1.

TABLE 1

| μ | Δf = 2^{μ} · 15 [kHz] | Cyclic prefix |
|---|---|---|
| 0 | 15 | Normal |
| 1 | 30 | Normal |
| 2 | 60 | Normal, Extended |
| 3 | 120 | Normal |
| 4 | 240 | Normal |
| 5 | 480 | Normal |

Regarding a frame structure in the NR system, a size of various fields in the time domain is expressed as a multiple of a time unit of Tₛ=1/(Δfₘₐₓ·N_{f}). In this case Δfₘₐₓ=480·10³, and N_{f}=4096. DL and UL transmission is configured as a radio frame having a section of T_{f}=(ΔfₘₐₓN_{f}/100)·Tₛ=10 ms. The radio frame is composed of ten subframes each having a section of T_{sf}=(ΔfₘₐₓN_{f}/1000)·Tₛ=1 ms. In this case, there may be a set of UL frames and a set of DL frames.

FIG. 2 illustrates a relationship between a UL frame and a DL frame in a wireless communication system to which a method proposed by the present disclosure may be implemented.

As illustrated in FIG. 2, a UL frame number I from a User Equipment (UE) needs to be transmitted T_{TA}=N_{TA}Tₛ before the start of a corresponding DL frame in the UE.

Regarding the numerology μ, slots are numbered in ascending order of nₛ^{μ}∈{0, . . . , N_{subframe}^{slots, μ}−1} in a subframe, and in ascending order of n_{s,f}^{μ}∈{0, . . . , N_{frame}^{slots,μ}−1} in a radio frame. One slot is composed of continuous OFDM symbols of N_{symb}^{μ}, and N_{symb}^{μ} is determined depending on a numerology in use and slot configuration. The start of slots nₛ^{μ} in a subframe is temporally aligned with the start of OFDM symbols nₛ^{μ}N_{symb}^{μ} in the same subframe.

Not all UEs are able to transmit and receive at the same time, and this means that not all OFDM symbols in a DL slot or an UL slot are available to be used.

Table 2 shows the number of OFDM symbols per slot for a normal CP in the numerology μ, and Table 3 shows the number of OFDM symbols per slot for an extended CP in the numerology μ.

TABLE 2

| | Slot configuration | | | | | |
|---|---|---|---|---|---|---|
| | 0 | | | 1 | | |
| μ | N_{symb}^{μ} | N_{frame}^{slots, μ} | N_{subframe}^{slots, μ} | N_{symb}^{μ} | N_{frame}^{slots, μ} | N_{subframe}^{slots, μ} |
| 0 | 14 | 10 | 1 | 7 | 20 | 2 |
| 1 | 14 | 20 | 2 | 7 | 40 | 4 |
| 2 | 14 | 40 | 4 | 7 | 80 | 8 |
| 3 | 14 | 80 | 8 | — | — | — |
| 4 | 14 | 160 | 16 | — | — | — |
| 5 | 14 | 320 | 32 | — | — | — |

TABLE 3

| | Slot configuration | | | | | |
|---|---|---|---|---|---|---|
| | 0 | | | 1 | | |
| μ | N_{symb}^{μ} | N_{frame}^{slots, μ} | N_{subframe}^{slots, μ} | N_{symb}^{μ} | N_{frame}^{slots, μ} | N_{subframe}^{slots, μ} |
| 0 | 12 | 10 | 1 | 6 | 20 | 2 |
| 1 | 12 | 20 | 2 | 6 | 40 | 4 |
| 2 | 12 | 40 | 4 | 6 | 80 | 8 |
| 3 | 12 | 80 | 8 | — | — | — |
| 4 | 12 | 160 | 16 | — | — | — |
| 5 | 12 | 320 | 32 | — | — | — |

NR Physical Resource

Regarding physical resources in the NR system, an antenna port, a resource grid, a resource element, a resource block, a carrier part, etc. may be considered.

Hereinafter, the above physical resources possible to be considered in the NR system will be described in more detail.

First, regarding an antenna port, the antenna port is defined such that a channel over which a symbol on one antenna port is transmitted may be inferred from another channel over which a symbol on the same antenna port is transmitted. When large-scale properties of a channel received over which a symbol on one antenna port may be inferred from another channel over which a symbol on another antenna port is transmitted, the two antenna ports may be in a QC/QCL (quasi co-located or quasi co-location) relationship. Herein, the large-scale properties may include at least one of delay spread, Doppler spread, Doppler shift, average gain, and average delay.

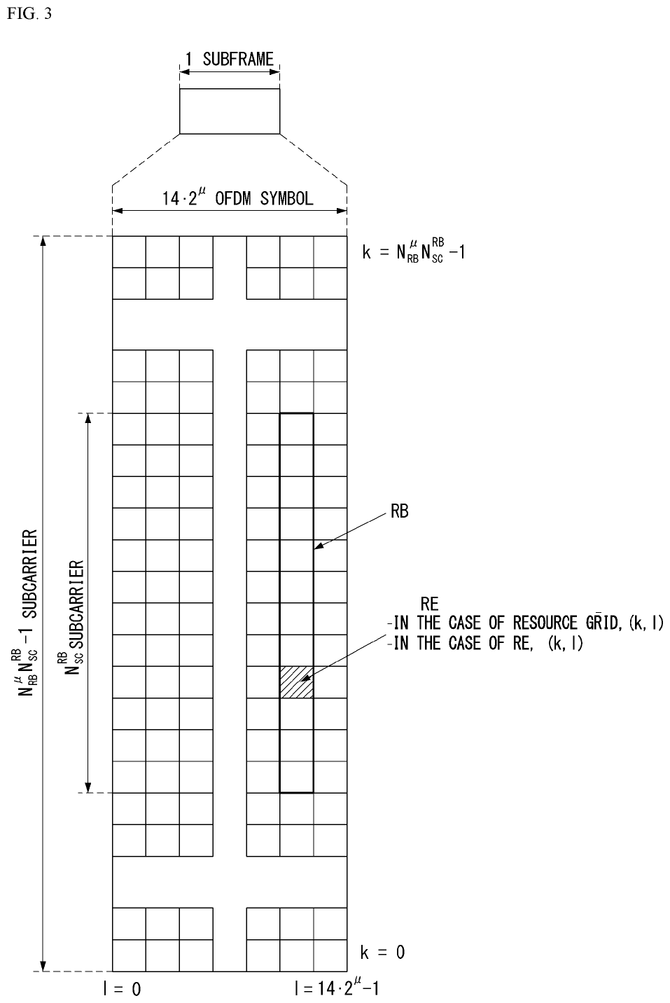

FIG. 3 illustrates an example of a resource grid supported in a wireless communication system to which a method proposed by the present disclosure may be implemented.

Referring to FIG. 3, a resource grid is composed of N_{RB}^{μ}N_{sc}^{RB} subcarriers in a frequency domain, each subframe composed of 14·2μ OFDM symbols, but the present disclosure is not limited thereto.

In the NR system, a transmitted signal is described by one or more resource grids, composed of N_{RB}^{μ}N_{sc}^{RB} subcarriers, and 2^{μ}N_{symb}^{(μ)} OFDM symbols. Herein, N_{RB}^{μ}≤N_{RB}^{max, μ}. The above N_{RB}^{max, μ} indicates the maximum transmission bandwidth, and it may change not just between numerologies, but between UL and DL.

In this case, as illustrated in FIG. 3, one resource grid may be configured for the numerology μ and an antenna port p.

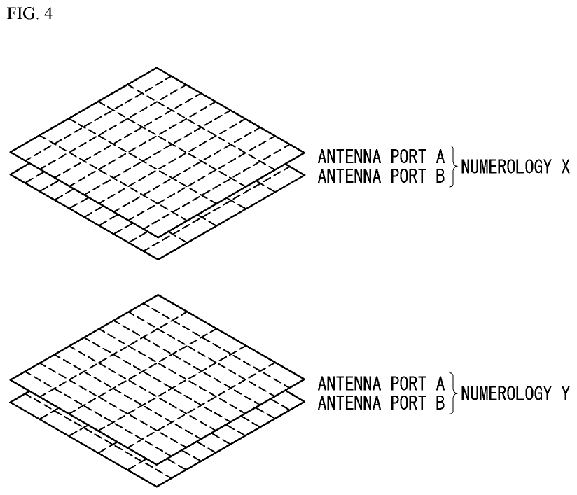

FIG. 4 illustrates examples of a resource grid per antenna port and numerology to which a method proposed by the present disclosure is applicable.

Each element of the resource grid for the numerology μ and the antenna port p is indicated as a resource element, and may be uniquely identified by an index pair (k,l̅) Herein, k=0, . . . , N_{RB}^{μ}N_{sc}^{RB}−1 is an index in the frequency domain, and l̅=0, . . . , 2^{μ}N_{symb}^{(μ)}−1 indicates a location of a symbol in a subframe. To indicate a resource element in a slot, the index pair (k,l̅) is used. Herein, l=0, . . . , N_{symb}^{μ}−1.

The resource element (k,l̅) for the numerology μ and the antenna port p corresponds to a complex value a_{k,l̅}^{(p,μ)}. When there is no risk of confusion or when a specific antenna port or numerology is specified, the indexes p and μ may be dropped and thereby the complex value may become a_{k,l̅}^{(p)} pr a_{k,l̅.}

In addition, a physical resource block is defined as N_{sc}^{RB}=12 continuous subcarriers in the frequency domain. In the frequency domain, physical resource blocks may be numbered from 0 to N_{RB}^{μ}−1. At this point, a relationship between the physical resource block number n_{PRB} and the resource elements (k,l) may be given as in Equation 1.

n_{PRB}=└N̅_̅{̅s̅c̅}̅^̅{̅R̅B̅}̅┘ [Equation 1]

In addition, regarding a carrier part, a UE may be configured to receive or transmit the carrier part using only a subset of a resource grid. At this point, a set of resource blocks which the UE is configured to receive or transmit are numbered from 0 to N_{URB}^{μ}−1 in the frequency region.

Uplink Control Channel

Physical uplink control signaling should be able to carry at least hybrid-ARQ acknowledgements, CSI reports (possibly including beamforming information), and scheduling requests.

At least two transmission methods are supported for an UL control channel supported in an NR system.

The UL control channel may be transmitted in short duration around last transmitted UL symbol(s) of a slot. In this case, the UL control channel is time-division-multiplexed and/or frequency-division-multiplexed with an UL data channel in a slot. For the UL control channel in short duration, transmission over one symbol duration of a slot is supported.

Short uplink control information (UCI) and data are frequency-division-multiplexed both within a UE and between UEs at least for the case where physical resource blocks (PRBs) for short UCI and data do not overlap.

In order to support time division multiplexing (TDM) of a short PUCCH from different UEs in the same slot, a mechanism is supported to inform the UE of whether symbol(s) in a slot to transmit the short PUCCH is supported at least above 6 GHz.

At least following is supported for the PUCCH in 1-symbol duration: 1) UCI and a reference signal (RS) are multiplexed in a given OFDM symbol in a frequency division multiplexing (FDM) manner if an RS is multiplexed, and 2) there is the same subcarrier spacing between downlink (DL)/uplink (UL) data and PUCCH in short-duration in the same slot.

At least a PUCCH in short-duration spanning 2-symbol duration of a slot is supported. In this instance, there is the same subcarrier spacing between DL/UL data and the PUCCH in short-duration in the same slot.

At least semi-static configuration, in which a PUCCH resource of a given UE within a slot. I.e., short PUCCHs of different UEs may be time-division multiplexed within a given duration in a slot, is supported.

The PUCCH resource includes a time domain, a frequency domain, and when applicable, a code domain.

The PUCCH in short-duration may span until an end of a slot from UE perspective. In this instance, no explicit gap symbol is necessary after the PUCCH in short-duration.

For a slot (i.e., DL-centric slot) having a short UL part, ‘short UCI’ and data may be frequency-division multiplexed by one UE if data is scheduled on the short UL part.

The UL control channel may be transmitted in long duration over multiple UL symbols so as to improve coverage. In this case, the UL control channel is frequency-division-multiplexed with the UL data channel within a slot.
UCI carried by a long duration UL control channel at least with a low peak to average power ratio (PAPR) design may be transmitted in one slot or multiple slots.
Transmission across multiple slots is allowed for a total duration (e.g. 1 ms) for at least some cases.
In the case of the long duration UL control channel, the TDM between the RS and the UCI is supported for DFT-S-OFDM.
A long UL part of a slot may be used for transmission of PUCCH in long-duration. That is, the PUCCH in long-duration is supported for both a UL-only slot and a slot having the variable number of symbols comprised of a minimum of 4 symbols.
For at least 1 or 2 UCI bits, the UCI may be repeated within N slots (N>1), and the N slots may be adjacent or may not be adjacent in slots where PUCCH in long-duration is allowed.
Simultaneous transmission of PUSCH and PUCCH for at least the long PUCCH is supported. That is, uplink control on PUCCH resources is transmitted even in the case of the presence of data. In addition to the simultaneous PUCCH-PUSCH transmission, UCI on the PUSCH is supported.
Intra-TTI slot frequency-hopping is supported.
DFT-s-OFDM waveform is supported.
Transmit antenna diversity is supported.

Both the TDM and the FDM between the short duration PUCCH and the long duration PUCCH are supported for different UEs in at least one slot. In a frequency domain, a PRB (or multiple PRBs) is a minimum resource unit size for the UL control channel. If hopping is used, a frequency resource and the hopping may not spread over a carrier bandwidth. Further, a UE-specific RS is used for NR-PUCCH transmission. A set of PUCCH resources is configured by higher layer signaling, and a PUCCH resource within the configured set is indicated by downlink control information (DCI).

As part of the DCI, timing between data reception and hybrid-ARQ acknowledgement transmission should be able to be dynamically indicated (at least in combination with RRC). A combination of the semi-static configuration and (for at least some types of UCI information) dynamic signaling is used to determine the PUCCH resource for both ‘long and short PUCCH formats’. Here, the PUCCH resource includes a time domain, a frequency domain, and when applicable, a code domain. The UCI on the PUSCH, i.e., using some of the scheduled resources for the UCI is supported in case of simultaneous transmission of UCI and data.

At least UL transmission of at least single HARQ-ACK bit is supported. A mechanism enabling the frequency diversity is supported. In case of ultra-reliable and low-latency communication (URLLC), a time interval between scheduling request (SR) resources configured for a UE may be less than a slot.

Beam Management

In NR, beam management is defined as follows.

Beam management: a set of L1/L2 procedures to acquire and maintain a set of TRP(s) and/or UE beams that may be used for DL and UL transmission/reception, which includes at least following aspects:
Beam determination: an operation for TRP(s) or UE to select its own transmission/reception beam.
Beam measurement: an operation for TRP(s) or UE to measure characteristics of received beamformed signals.
Beam reporting: an operation for UE to report information of beamformed signal based on beam measurement.
Beam sweeping: an operation of covering a spatial area using transmitted and/or received beams during a time interval in a predetermined way.

Also, the followings are defined as Tx/Rx beam correspondence at the TRP and the UE.
Tx/Rx beam correspondence at TRP holds if at least one of the followings is satisfied.
The TRP is able to determine a TRP reception beam for the uplink reception based on UE's downlink measurement on TRP's one or more transmission beams.
The TRP is able to determine a TRP Tx beam for the downlink transmission based on TRP's uplink measurement on TRP's one or more Rx beams.
Tx/Rx beam correspondence at UE holds if at least one of the followings is satisfied.
The UE is able to determine a UE Tx beam for the uplink transmission based on UE's downlink measurement on UE's one or more Rx beams.
The UE is able to determine a UE reception beam for the downlink reception based on TRP's indication based on uplink measurement on UE's one or more Tx beams.
Capability indication of UE beam correspondence related information to TRP is supported.

The following DL L1/L2 beam management procedures are supported within one or multiple TRPs.

P-1: is used to enable UE measurement on different TRP Tx beams so as to support selection of TRP Tx beams/UE Rx beam(s).
In case of beamforming at the TRP, it generally includes intra/inter-TRP Tx beam sweep from a set of different beams. For beamforming at the UE, it typically includes UE Rx beam sweep from a set of different beams.

P-2: is used to enable UE measurement on different TRP Tx beams to change inter/intra-TRP Tx beam(s).

P-3: is used to enable UE measurement on the same TRP Tx beam to change UE Rx beam in the case where the UE uses beamforming.

At least network triggered aperiodic reporting is supported under P-1, P-2, and P-3 related operations.

The UE measurement based on an RS for the beam management (at least CSI-RS) is composed of K beams (where K is a total number of beams), and the UE reports measurement results of N selected Tx beams, where N is not necessarily fixed number. A procedure based on an RS for mobility purpose is not precluded. Reporting information at least includes measurement quantities for N beam(s) and information indicating N DL transmission beam(s), if N<K. Specifically, for K′>1 non-zero power (NZP) CSI-RS resources of the UE, the UE may report N′ CRI (CSI-RS resource indicator).

The UE may be configured with the following higher layer parameters for beam management.
N≥1 reporting settings, M≥1 resource settings
Links between reporting settings and resource settings are configured in the agreed CSI measurement setting.
CSI-RS based P-1 and P-2 are supported with resource and reporting settings.
P-3 may be supported with or without the reporting setting.
A reporting setting including at least the followings
Information indicating selected beam
L1 measurement reporting
Time domain behavior (e.g. Aperiodic operation, periodic operation, and semi-persistent operation)
Frequency granularity if several frequency granularities are supported
A resource setting including at least the followings
Time domain behavior (e.g. Aperiodic operation, periodic operation, and semi-persistent operation)
RS type: at least NZP CSI-RS
At least one CSI-RS resource set. Each CSI-RS resource set includes K≥1 CSI-RS resources (some parameters of K CSI-RS resources may be the same. For example, port number, time domain behavior, density and periodicity).

Also, NR supports the following beam reporting considering L groups, where L>1.
Information indicating at least group
Measurement quantity for N1 beam (supporting of L1 RSRP and CSI report (when CSI-RS is for CSI acquirement))
Information indicating N1 DL transmission beam, if applicable

The above-described group based beam reporting may be configured per UE basis. The above group based beam reporting may be turned off per UE basis (e.g. When L=1 or NI=1).

NR supports that the UE may trigger a mechanism recovering from a beam failure.

A beam failure event occurs when the quality of beam pair link(s) of an associated control channel is low enough (e.g. comparison with a threshold value, time-out of an associated timer). The mechanism to recover from the beam failure (or beam obstacle) is triggered when the beam failure occurs.

A network explicitly configures to the UE with resources for transmitting UL signals for recovery purpose. Configurations of resources are supported where the base station is listening from all or some directions (e.g. random access region).

The UL transmission/resources to report the beam failure may be located at the same time instance as PRACH (resources orthogonal to PRACH resources) or at a time instance (configurable for the UE) different from the PRACH. The transmission of DL signal is supported for allowing the UE to monitor beams for identifying new potential beams.

NR supports the beam management regardless of a beam-related indication. When the beam-related indication is provided, information pertaining to a UE-side beamforming/receiving procedure used for CSI-RS-based measurement may be indicated to the UE through QCL. As QCL parameters to support in NR, a spatial parameter for beamforming at a receiver will be added as well as parameters for delay, Doppler, average gain, etc. That have been used in a LTE system. The QCL parameters may include angle-of-arrival related parameters from UE reception beamforming perspective and/or angle-of-departure related parameters from base station reception beamforming perspective. NR supports using the same beam or different beams on control channel and corresponding data channel transmissions.

For NR-PDCCH (physical downlink control channel) transmission supporting robustness against beam pair link blocking, the UE may be configured to monitor NR-PDCCH on M beam pair links simultaneously, where M≥1 and a maximum value of M may depend on at least UE capability.

The UE may be configured to monitor NR-PDCCH on different beam pair link(s) in different NR-PDCCH OFDM symbols. Parameters related to UE Rx beam setting for monitoring NR-PDCCH on multiple beam pair links are configured by higher layer signaling or MAC CE and/or considered in a search space design.

At least, NR supports an indication of spatial QCL assumption between DL RS antenna port(s) and DL RS antenna port(s) for demodulation of DL control channel. Candidate signaling methods for beam indication for a NR-PDCCH (i.e. configuration method to monitor NR-PDCCH) are MAC CE signaling, RRC signaling, DCI signaling, specification-transparent and/or implicit method, and combination of these signaling methods.

For reception of unicast DL data channel, NR supports an indication of spatial QCL assumption between a DL RS antenna port and a DMRS antenna port of DL data channel.

Information indicating an RS antenna port is indicated via DCI (downlink grant). The information indicates the RS antenna port which is QCL-ed with the DMRS antenna port. A different set of DMRS antenna ports for the DL data channel may be indicated as QCL with a different set of RS antenna ports.

Hybrid Beamforming

Existing beamforming technology using multiple antennas may be classified into an analog beamforming scheme and a digital beamforming scheme according to a location to which beamforming weight vector/precoding vector is applied.

The analog beamforming scheme is a beamforming technique applied to an initial multi-antenna structure. The analog beamforming scheme may mean a beamforming technique which branches analog signals subjected to digital signal processing into multiple paths and then applies phase-shift (PS) and power-amplifier (PA) configurations for each path.

For analog beamforming, a structure in which an analog signal derived from a single digital signal is processed by the PA and the PS connected to each antenna is required. In other words, in an analog stage, a complex weight is processed by the PA and the PS.

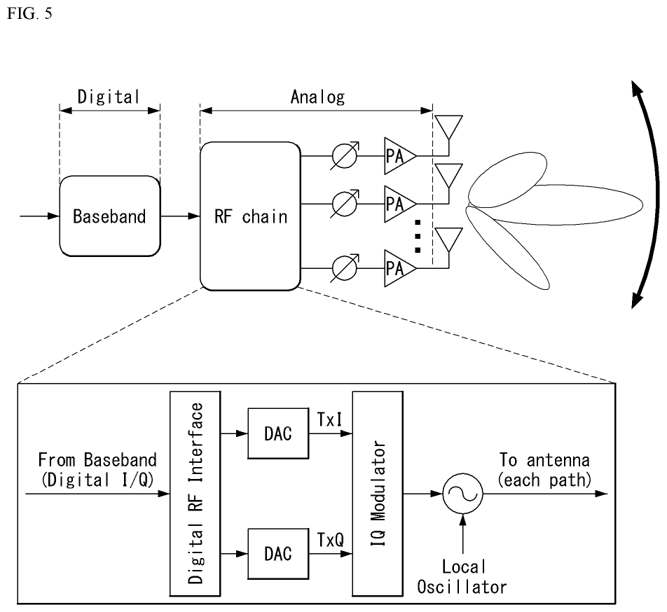

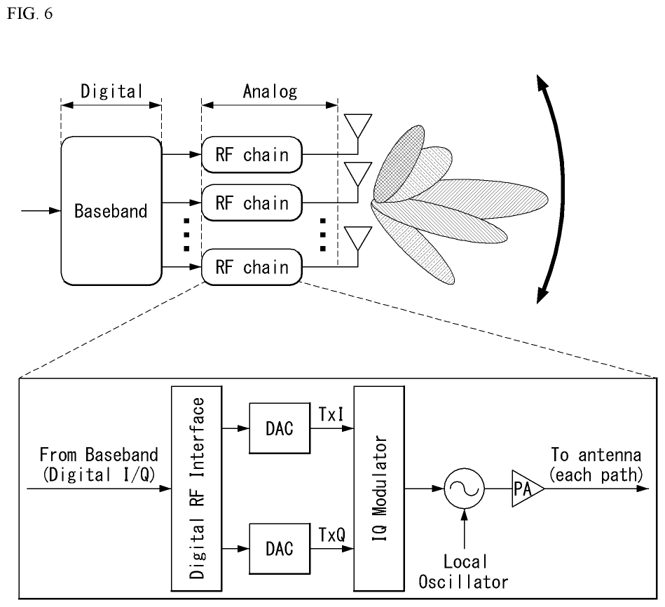

FIG. 5 illustrates an example of a block diagram of a transmitter composed of an analog beamformer and an RF chain. FIG. 5 is merely for convenience of explanation and does not limit the scope of the present disclosure.

In FIG. 5, the RF chain means a processing block for converting a baseband (BB) signal into an analog signal. The analog beamforming scheme determines beam accuracy according to characteristics of elements of the PA and PS and may be suitable for narrowband transmission due to control characteristics of the elements.

Further, since the analog beamforming scheme is configured with a hardware structure in which it is difficult to implement multi-stream transmission, a multiplexing gain for transfer rate enhancement is relatively small. In addition, in this case, beamforming per UE based on orthogonal resource allocation may not be easy.

On the contrary, in the case of digital beamforming scheme, beamforming is performed in a digital stage using a baseband (BB) process in order to maximize diversity and multiplexing gain in a MIMO environment.

FIG. 6 illustrates an example of a block diagram of a transmitter composed of a digital beamformer and an RF chain. FIG. 6 is merely for convenience of explanation and does not limit the scope of the present disclosure.

In FIG. 6, beamforming may be performed as precoding is performed in the BB process. Here, the RF chain includes a PA. This is because a complex weight derived for beamforming is directly applied to transmission data in the case of digital beamforming scheme.

Furthermore, since different beamforming may be performed per UE, it is possible to simultaneously support multi-user beamforming. Besides, since independent beamforming may be performed per UE to which orthogonal resources are assigned, scheduling flexibility may be improved and thus a transmitter operation suitable for the system purpose may be performed. In addition, if a technology such as MIMO-OFDM is applied in an environment supporting wideband transmission, independent beamforming may be performed per subcarrier.

Accordingly, the digital beamforming scheme may maximize a maximum transfer rate of a single UE (or user) based on system capacity enhancement and enhanced beam gain. On the basis of the above-described properties, digital beamforming based MIMO scheme has been introduced to existing 3G/4G (e.g. LTE(-A)) system.

In the NR system, a massive MIMO environment in which the number of transmit/receive antennas greatly increases may be considered. In cellular communication, a maximum number of transmit/receive antennas applied to an MIMO environment is assumed to be 8. However, as the massive MIMO environment is considered, the number of transmit/receive antennas may increase to above tens or hundreds.

If the aforementioned digital beamforming scheme is applied in the massive MIMO environment, a transmitter needs to perform signal processing on hundreds of antennas through a BB process for digital signal processing. Hence, signal processing complexity may significantly increase, and complexity of hardware implementation may remarkably increase because as many RF chains as the number of antennas are required.

Furthermore, the transmitter needs to perform independent channel estimation for all the antennas. In addition, in case of an FDD system, since the transmitter requires feedback information on a massive MIMO channel composed of all antennas, pilot and/or feedback overhead may considerably increase.

On the other hand, when the aforementioned analog beamforming scheme is applied in the massive MIMO environment, hardware complexity of the transmitter is relatively low.

However, an increase degree of a performance using multiple antennas is very low, and flexibility of resource allocation may decrease. In particular, it is difficult to control beams per frequency in the wideband transmission.

Accordingly, instead of exclusively selecting only one of the analog beamforming scheme and the digital beamforming scheme in the massive MIMO environment, there is a need for a hybrid transmitter configuration scheme in which an analog beamforming structure and a digital beamforming structure are combined.

Analog Beam Scanning

In general, analog beamforming may be used in a pure analog beamforming transmitter/receiver and a hybrid beamforming transmitter/receiver. In this instance, analog beam scanning may perform estimation for one beam at the same time. Thus, a beam training time required for the beam scanning is proportional to the total number of candidate beams.

As described above, the analog beamforming necessarily requires a beam scanning process in a time domain for beam estimation of the transmitter/receiver. In this instance, an estimation time Tₛ for all of transmit and receive beams may be represented by the following Equation 2.

T_{S}=tₛ×(K_{T}×K_{R}) [Equation 2]

In Equation 2, is denotes time required to scan one beam, K_{T} denotes the number of transmit beams, and K_{R} denotes the number of receive beams.

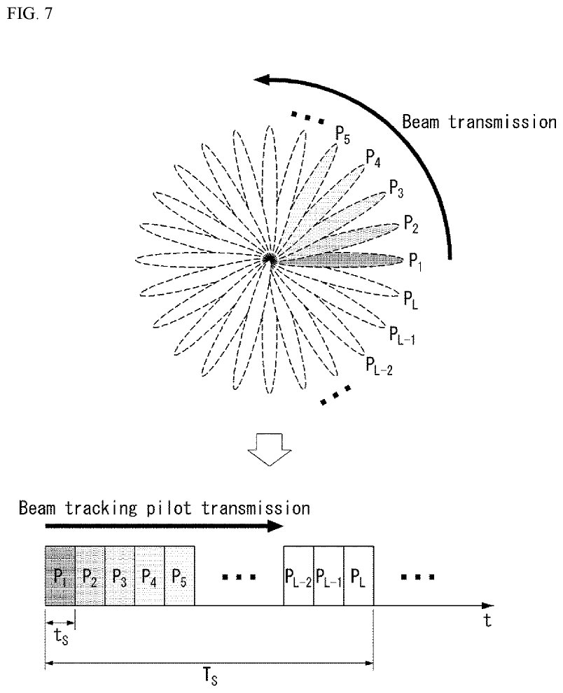

FIG. 7 illustrates an example of an analog beam scanning scheme according to various embodiments of the present disclosure. FIG. 7 is merely for convenience of explanation and does not limit the scope of the present disclosure.

In FIG. 7, it is assumed that the total number K_{T} of transmit beams is L, and the total number K_{R} of receive beams is 1. In this case, since the total number of candidate beams is L, L time intervals are required in the time domain.

In other words, since only the estimation of one beam may be performed in a single time interval for analog beam estimation, L time intervals are required to estimate all of L beams P1 to PL as shown in FIG. 7. The UE feeds back, to the base station, an identifier (ID) of a beam with a highest signal strength after an analog beam estimation procedure is ended. Namely, as the number of individual beams increases according to an increase in the number of transmit/receive antennas, a longer training time may be required.

Because the analog beamforming changes a magnitude and a phase angle of a continuous waveform of the time domain after a digital-to-analog converter (DAC), a training interval for an individual beam needs to be secured for the analog beamforming, unlike the digital beamforming. Thus, as a length of the training interval increases, efficiency of the system may decrease (i.e., a loss of the system may increase).

Channel State Information (CSI) Feedback

In most cellular systems including the LTE system, a UE receives a pilot signal (reference signal) for channel estimation from a base station, calculates channel state information (CSI), and reports the calculated CSI to the base station.

The base station transmits a data signal based on the CSI fed back from the UE.

In the LTE system, the CSI fed back by the UE includes channel quality information (CQI), a precoding matrix index (PMI), and a rank indicator (RI).

CQI feedback is radio channel quality information provided to the base station for the purpose (link adaptation purpose) of providing a guide as to which modulation and coding scheme (MCS) the base station applies when transmitting data.

If radio quality between the base station and the UE is high, the UE may feedback a high CQI value to the base station, and the base station may transmit data using a relatively high modulation order and a low channel coding rate. On the contrary, if radio quality between the base station and the UE is low, the UE may feedback a low CQI value to the base station, and the base station may transmit data using a relatively low modulation order and a high channel coding rate.

PMI feedback is preferred precoding matrix information provided to the base station for the purpose of providing a guide as to which MIMO precoding scheme the base station applies when installing multiple antennas.

The UE estimates a downlink MIMO channel between the base station and the UE from the pilot signal and recommends which MIMO precoding scheme is applied to the base station through the PMI feedback.

In the LTE system, only linear MIMO precoding that is representable in the form of a matrix is considered in PMI configuration.

The base station and the UE share a codebook composed of multiple precoding matrices, and each MIMO precoding matrix within the codebook has a unique index.

Accordingly, the UE feeds back an index corresponding to a most preferred MIMO precoding matrix within the codebook as a PMI to thereby minimize an amount of feedback information of the UE.

A PMI value needs not be necessarily configured as one index. For example, in the LTE system, when the number of transmit antenna ports is 8, a final 8tx MIMO precoding matrix may be derived by combining two indices (i.e., a first PMI and a second PMI).

RI feedback is information on the number of preferred transmission layers provided to the base station for the purpose of providing a guide to the number of transmission layers preferred by the UE when the UE and the base station enable multi-layer transmission through spatial multiplexing by installing multiple antennas.

The RI has a very close relationship with the PMI. This is because the base station needs to know which precoding will be applied to each layer according to the number of transmission layers.

In PMI/RI feedback configuration, a method of configuring a PMI codebook on the basis of single layer transmission, defining a PMI per layer and feeding back the PMI may be considered. However, the method has a disadvantage in that an amount of PMI/RI feedback information greatly increases due to an increase in the number of transmission layers.

Accordingly, in the LTE system, a PMI codebook has been defined per number of transmission layers. That is, N Nt×R matrices are defined in a codebook for R-layer transmission, where R is the number of layers, Nt is the number of transmit antenna ports, and N is the size of the codebook.

Accordingly, in the LTE system, the size of a PMI codebook is defined irrespective of the number of transmission layers. Since the number R of transmission layers is eventually equal to a rank value of a precoding matrix (Nt×R matrix) as the PMI/RI is defined with such a structure, a term of rank indicator (RI) has been used.

The PMI/RI described in the present disclosure is not limited to mean an index value and a rank value of a precoding matrix represented as Nt×R matrix, like PMI/RI in the LTE system.

The PMI described in the present disclosure indicates information of a preferred MIMO precoder among MIMO precoders applicable to a transmitter, and a form of the precoder is not limited to only a linear precoder that may be represented as a matrix as in the LTE system. Further, the RI described in the present disclosure is interpreted in a broader sense than RI in LTE and includes all of feedback information indicating the number of preferred transmission layers.

The CSI may be obtained in all of system frequency domains and may be also obtained in some frequency domains. In particular, it may be useful for a wideband system to obtain CSI for some preferred frequency domains (e.g. Subband) per UE and feedback the CSI.

In the LTE system, CSI feedback is performed on an uplink channel. In general, periodic CSI feedback is performed on a physical uplink control channel (PUCCH), and aperiodic CSI feedback is performed on a physical uplink shared channel (PUSCH) which is an uplink data channel.

The aperiodic CSI feedback is temporarily performed only when the base station desires CSI feedback information, and the base station triggers the CSI feedback on a downlink control channel such as PDCCH/ePDCCH.

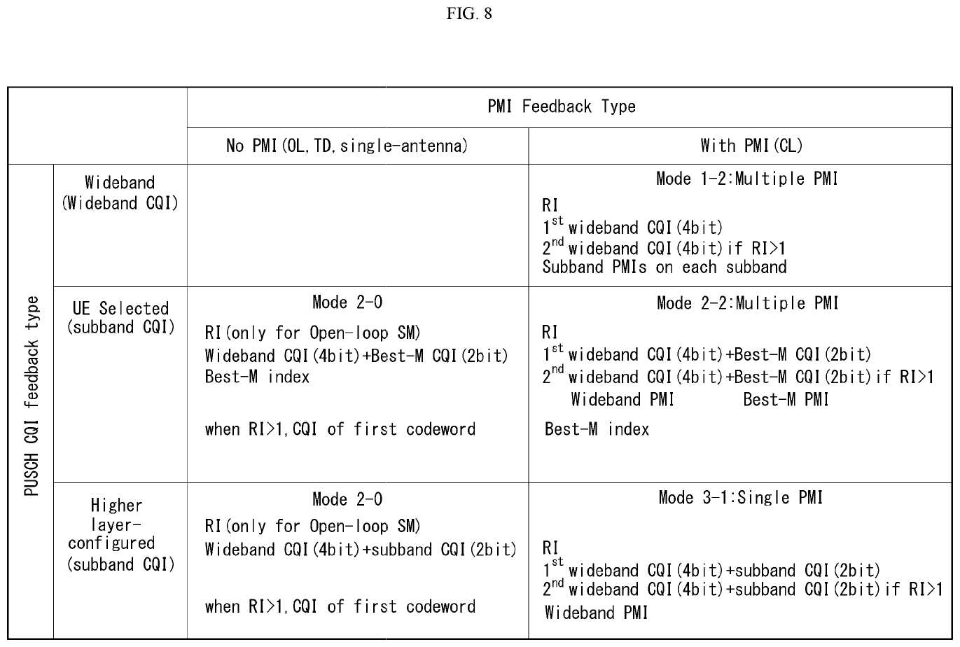

When the CSI feedback has been triggered in the LTE system, which information the UE should feedback is classified into PUSCH CSI reporting modes as shown in FIG. 8. The UE is previously informed of which PUSCH CSI reporting mode the UE should operate in through a higher layer message.

FIG. 8 illustrates an example of a PUSCH CSI reporting mode.

The PUCCH CSI reporting mode is also defined for the periodic CSI feedback on the PUCCH.

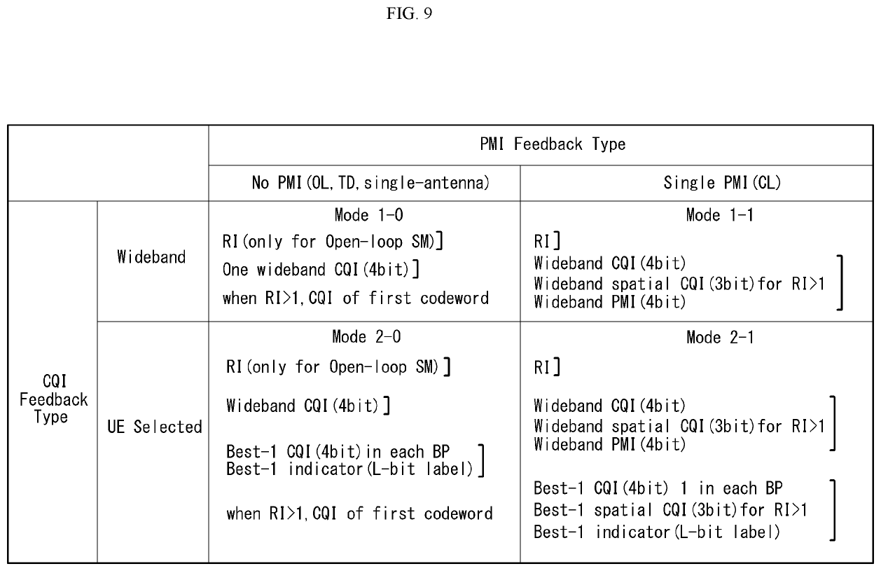

FIG. 9 illustrates an example of a PUCCH CSI reporting mode.

In the case of PUCCH, since an amount (i.e., a payload size) of data which may be transmitted at once is less than that in the PUSCH, it is difficult to transmit CSI, that needs to be transmitted, at once.

Accordingly, a time at which CQI and PMI are transmitted and a time at which RI is transmitted are different from each other according to each CSI reporting mode. For example, in reporting mode 1-0, only RI is transmitted at a specific PUCCH transmission time, and wideband CQI is transmitted at another PUCCH transmission time. A PUCCH reporting type is defined according to kinds of CSI configured at the specific PUCCH transmission time. For example, a reporting type of transmitting only the RI corresponds to type 3, and a reporting type of transmitting only the wideband CQI corresponds to type 4. A feedback periodicity and an offset value of the RI and a feedback periodicity and an offset value of CQI/PMI are configured to the UE through higher layer message.

The above CSI feedback information is included in uplink control information (UCI).

Reference Signals in LTE

In the LTE system, the purpose of a pilot signal or a reference signal (RS) may be roughly divided as follows.

1. Measurement RS: pilot for channel state measurement

A. CSI measurement/reporting purpose (short term measurement): purpose of link adaptation, rank adaptation, closed loop MIMO precoding, etc.

B. Long term measurement/reporting purpose: purpose of handover, cell selection/reselection, etc.

2. Demodulation RS: pilot for physical channel reception

3. Positioning RS: pilot for UE location estimation

4. MBSFN RS: pilot for multi-cast/broadcast service

In LTE Rel-8, a cell-specific RS (CRS) has been used for measurement (purpose 1 A/B) and demodulation (purpose 2) for most of downlink physical channels. However, in order to solve RS overhead problem due to an increase in the number of antennas, from LTE Advanced (Rel-10), a CSI-RS is used dedicatedly for CSI measurement (purpose 1A), and a UE-specific RS is used dedicatedly for the reception (purpose 2) of downlink data channel (PDSCH).

The CSI-RS is an RS designed dedicatedly for the CSI measurement and feedback and is characterized by having an RS overhead much lower than the CRS. The CRS supports up to 4 antenna ports, whereas the CSI-RS is designed to support up to 8 antenna ports. The UE-specific RS is designed dedicatedly for demodulation of a data channel and, unlike the CRS, is characterized in that it is an RS (precoded RS) in which a MIMO precoding scheme applied when data is transmitted to the corresponding UE is equally applied to a pilot signal.

Accordingly, as many UE-specific RSs as the number of antenna ports do not need to be transmitted as in the CRS and the CSI-RS, and as many UE-specific RSs as the number of transmission layers (i.e., transmission ranks) are transmitted.

Further, since the UE-specific RS is transmitted for the data channel reception purpose of the corresponding UE in the same resource region as a data channel resource region allocated to each UE through a scheduler of the base station, it is characterized to be UE-specific.

In addition, since the CRS is always transmitted in the same pattern within a system bandwidth so that all of UEs within the cell may use the CRS for the purposes of measurement and demodulation, it is cell-specific.

In LTE uplink, a sounding RS (SRS) has been designed as a measurement RS, and a demodulation RS (DMRS) for an uplink data channel (PUSCH) and a DMRS for an uplink control channel (PUCCH) for ACK/NACK and CSI feedback have been individually designed.

Beam Management and Beam Recovery

The BS may request periodic CSI reporting, semi-persistent CSI reporting (periodic CSI reporting is activated only during a specific time interval or CSI reporting is performed a plurality of successive times), or aperiodic CSI reporting from the UE.

Here, as for the periodic and semi-persistent (SP) CSI reporting, a UL (uplink) resource (e.g., PUCCH in LTE) for CSI reporting is allocated to the UE at a specific period.

In order to measure CSI of a UE, it is required to transmit a downlink (DL) reference signal (RS) of the BS.

In the case of a beamformed system to which (analog) beamforming is applied, it is necessary to determine a DL transmission (Tx)/reception (Rx) beam pair and a UL Tx/Rx beam pair for uplink control information (UCI) (e.g., CSI, ACK/NACK) transmission/reception.

The procedure for determining the DL beam pair may include a combination of (1) a procedure in which a BS transits a DL RS corresponding to a plurality of TRP Tx beams to a UE, (2) a TRP Tx beam selecting procedure in which the UE selects and/or reports one of them, (3) a procedure in which the BS repeatedly transmits the same RS signal corresponding to each TRP Tx beam, and (4) a procedure in which the UE measures the repeated transmitted signals with different UE Rx beams and selecting a UE Rx beam.

In addition, the procedure for determining the UL beam pair may include a combination of (1) a procedure in which the BS transmits a UL RS corresponding to a plurality of UE Tx beams, 2) a procedure in which the BS selects and/or signals one of them, (3) a procedure in which the UE repeatedly transmits the same RS signal corresponding to each UE Tx beam to the BS, and (4) a procedure in which the BS measures the repeatedly transmitted signals with different TRP Rx beams to select a TRP Rx beam.

When beam reciprocity (or beam correspondence) of the DL/UL is established, that is, the BS DL Tx beam and the BS UL Rx beams are matched and a UE UL Tx beam and a UE DL Rx beam are matched in communication between the BS and the UE, if only one of the DL beam pair and the UL beam pair is determined, a procedure of determining the other may be omitted.

The process for determining the DL and/or UL beam pair may be performed periodically or aperiodically.

When the number of candidate beams is large, it is not preferable that the process for determining the DL and/or UL beam pair occurs frequently because required RS overhead may be large.

It is assumed that the UE performs periodic or semi-persistent CSI reporting after the DL/UL beam pair determination process is completed.

Here, a CSI-RS including a single or a plurality of antenna ports for the CSI measurement of the UE may be beamformed with a TRP Tx beam determined as a DL beam and transmitted, a transmission period of the CSI-RS may be the same as or more often than the CSI reporting period.

Alternatively, the UE may transmit an aperiodic CSI-RS in conformity with the CSI reporting period or more frequently.

A terminal (e.g., a UE) may periodically transmit the measured CSI information to the UL Tx beam determined in the UL beam pair determination process.

In performing the DL/UL beam management process, beam mismatch may occur according to a set period of beam management.

In particular, when the UE moves its position, the UE rotates, or a wireless channel environment is changed due to movement of an object near the UE (for example, a line-of-sight (LoS) environment is changed to a non-LoS environment as the beam is blocked), the optimal DL/UL beam pair may be changed.

It may be considered that a beam failure event occurs when tracking fails due to a beam management process which generally performs such a change by a network indication.

The occurrence of such a beam failure event may be determined by the UE through reception quality of a downlink RS, and a report message for such a situation or a message for requesting beam recovery (hereinafter, referred to as a ‘beam recovery request message’) must be delivered from the UE.

The beam recovery request message may be variously expressed as a beam failure recovery request message, a control signal, a control message, a first message, or the like.

The BS receiving the beam recovery request message from the UE may perform beam recovery through various processes such as beam RS transmission and beam reporting request to the UE for beam recovery.

This series of beam recovery processes will be referred to as “beam recovery.”

Standardization of a new communication system named new radio or new rat (NR) is in progress after LTE in 3GPP, and the followings are related to beam management.

(Contents 1)

The NR supports that the UE may trigger a mechanism to recover from beam failure.

The network explicitly configures the UE for the UL transmission of signals for recovery purposes.

The BS supports a configuration of resources that that BS are listening from all or part of the directions (e.g., random access area).

(Discussion later) Trigger condition for recovery signal (new or existing signal) related to UE operation in RS/control channel/data channel monitoring

It supports transmission of a DL signal allowing the UE to monitor a beam to identify new potential beams.

(Discussion later) Transmission of a beam sweep control channel is not excluded.

This mechanism must consider tradeoff between performance and DL signaling overhead.

(Contents 2)

A beam management overhead and a delay time must be considered during CSI-RS design for NR beam management in consideration of the following possible candidate solution.

Opt1. IFDMA

Opt2. large subcarrier spacing

Other aspects considered during CSI-RS design for NR beam management include, for example, CSI-RS multiplexing, UE beam switch latency and UE implementation complexity (e.g., AGC training time), coverage of CSI-RS and the like.

(Contents 3)

CSI-RS supports DL Tx beam sweeping and UE Rx beam sweeping.

The NR CSI-RS supports the following mapping structure.

An NP CSI-RS port may be mapped for each (sub)time unit.

The same CSI-RS antenna ports may be mapped over a (sub)time unit.

Here “time unit” denotes n>=1 OFDM symbol in configured/reference numerology.

Each time unit may be partitioned into sub-time units.

This mapping structure may be used to support multiple panels/Tx chains.

(Option 1)

The Tx beam(s) are identical over subtime units within each time unit.

Tx beam(s) vary according to time units.

(Option 2)

The Tx beam(s) are different for each subtime unit within in time unit.

The Tx beam(s) are the same in time units.

(Option 3): Combination of Option 1 and Option 2

The Tx beam(s) are the same in subtime units in one time unit.

The Tx beam(s) are different for each subtime unit in other time units.

Hereinafter, a beam failure recovery mechanism of the UE will be briefly described.

The beam failure recovery mechanism of the UE includes the following steps (1) to (4).

(1) Beam failure is detected.

(2) New candidate beam is identified.

(3) Beam failure recovery request is transmitted.

(4) UE monitors a gNB's response on the beam failure recovery request.

First, a beam failure detection process will be described. The UE monitors a beam failure detection RS to evaluate whether a beam failure trigger condition is satisfied.

The beam failure detection RS includes at least periodic CSI-RS for beam management. Here, a synchronization signal (SS) block may also be used for beam management, and when the SS block is used for beam management, an SS block in a serving cell may be considered.

Here, the SS block may be interpreted such that a synchronization signal SS is transmitted in a slot unit or a specific time unit.

Here, the beam failure detection RS includes not only a case of measuring quality itself of the corresponding RS but also a case of measuring detection/demodulation quality of a radio channel associated with the RS by a quasi-co-location (QCL) indicator. For example, a CSI-RS indicated for (primary) PDCCH monitoring or an SS block related ID may be understood as the beam failure detection RS, and here, whether the beam failure event occurs may be defined as a case where a detection/demodulation performance of the corresponding PDCCH is below a certain level.

The beam failure event may occur when quality of a beam pair link(s) of the associated control channel drops below a certain level.

Specifically, quality of the beam pair link(s) of the associated control channel may be determined by PDCCH detection performance.

For example, if PDCCH detection performance is not good according to a CR check result in the process in which the UE monitors (or blind decodes) the PDCCH, the UE may detect a beam failure.

Alternatively, when multiple PDCCHs are transmitted through multiple beams (or multiple PDCCHs are transmitted in different beams, respectively), whether the beam failure event occurs may be determined by detection performance of a specific PDCCH (e.g., PDCCH associated with a serving beam).

Here, the multiple PDCCHs may be transmitted and/or received by different beams in different control channel regions (e.g., symbol, slot, subframe, etc.), respectively.

In this case, a control channel region for each beam may be predefined or transmitted/received through higher layer signaling.

In addition, when determining whether the beam failure event occurs based on quality of the beam pair link(s) of the associated control channel, whether the beam failure event occurs may be determined according to whether only quality of the DL beam falls below a predetermined level, whether only quality of the UL beam falls below the predetermined level, or whether the quality of both the DL beam and the UL beam falls below the certain level.

Here, the predetermined level or less may be equal to or less than a threshold, time-out of an associated timer, and the like.

In addition, a BRS, an RS for fine timing/frequency tracking, SS-blocks, DM-RS for PDCCH, DM-RS for PDSCH, and the like may be used as a signal for detecting the beam failure.

Next, referring to a new candidate beam identification process, the UE monitors a beam identification RS to find a new candidate beam.
The beam identification RS includes 1) information on a periodic CSI-RS for beam management, if configured by NW, and 2) periodic CSI-RS and SS block in a serving cell, if SS block is used for beam management.

Next, referring to a beam failure recovery request transmission process, information carried by a beam failure recovery request may include at least one of 1) explicit/implicit information for identifying UE and new gNB TX beam information, or 2) explicit/implicit information for identifying a UE and regarding whether new candidate beam exists.

Further, transmission of the beam failure recovery request may select one of PRACH, PUCCH, PRACH-like (e.g., different parameters for preamble sequence from PRACH).
The beam failure recovery request resource/signal may be used in addition to a scheduling request.

Next, the UE monitors a control channel search space to receive a gNB response on the beam failure recovery request.

In addition, the following triggering conditions are supported for beam failure recovery request transmission.
Condition: if only CSI-RS is used for new candidate beam identification, if beam failure is detected and candidate beam is identified.

In addition, the following channels are supported for the beam failure recovery request transmission.

A resource orthogonal to a resource of different PRACH transmission is used for a competition-free based channel based on the PRACH and FDM.
A PUCCH for beam failure recovery request transmission is supported.

As described above, in the case of NR, a beam recovery request message may support both (1) transmission using the same symbols as the PRACH (first) and (2) transmission using symbols other than the PRACH (second).

The first may be a mechanism useful when even uplink synchronization is lost due to beam failure (beam quality is relatively poor or there is no alternative beam) and/or when a beam failure event occurrence time point and a preset PRACH resource are close in time.

The second may be a mechanism useful when a beam failure situation or uplink synchronization is not lost (beam quality is relatively low or there is an alternative beam) and/or when it is difficult to perform fast beam recovery to wait for a PRACH resource (e.g., symbol) because the beam failure event occurrence time point and the preset PRACH resource are away from each other in time.

In addition, in the case of beam failure, if the UE fails to receive a response to a request after transmitting from the BS after transmitting a beam recovery request message to the BS predetermined number of times, the UE may perform a radio link failure (RLF) operation.

Hereinafter, a method for recovering a beam when beam failure occurs due to movement of the UE or the like.

In particular, in the present disclosure, a method for recovering a beam may be performed differently according to the presence of an alternative beam, and details thereof will be described later.

A beam reference signal) (BRS) used in the present disclosure is a downlink physical signal used for beam management, and a CSI-RS, a mobility RS (MRS), a synchronization signal, and the like may be used as the BRS.

The beam RS may be set (as an RRC layer message) by resource setting on a beam management framework (or CSI framework). That is, the beam RS may be previously set by the resource setting.

As described later, the beam management framework is a structure indicating a relationship between beam reporting setting(s), beam resource setting(s), a beam resource set, measurement setting(s). Details thereof will be described later.

In addition, beam reporting used in the present disclosure refers to feedback information of a UE associated with a beam and may include beam quality related information and/or beam indication information.

In the present disclosure, CA and/or B′, CA and/or B′, and ‘A/B’ may be interpreted to have the same meaning as ‘including at least one of A or B’.

The beam quality related information may be channel quality information (CQI), layer 3 reference signals received Power (RSRP), Layer 1 RSRP, or the like.

In addition, the beam indication information may be a CSI-RS resource indicator (CRI), a precoding matrix indicator (PMI), an RS port index, or the like.

Feedback information, parameters, reporting periods, and granularity (e.g., wideband feedback, subband feedback) related to the beam may be set (as an RRC layer message) by a reporting setting on the beam management framework (or CSI framework).

That is, the feedback information, the reporting period, granularity, etc. related to the beam may be previously set by the reporting setting.

When the UE transmits a beam recovery request to a network (e.g., a BS), the network may perform two operations (method 1 and method 2) as follows.

(Method 1)

The method 1 illustrates a network operation in the absence of an alternative beam (e.g., an alternative DL beam pair).

That is, the method 1 relates to a method of transmitting an (aperiodic) beam RS to the UE (or triggering a beam RS) and transmitting an (aperiodic) beam reporting trigger to the UE when the network receives a beam recovery request from the UE.

The alternative beam may be understood as an RS set configured by a BS for periodic beam management or monitoring and may be equal to or smaller than a set of beams that the UE may be able to measure.

That is, the alternative beam may be an RS(s) having a specific quality or higher among RSs configured for beam management purposes.

For example, the network may configure N CSI-RS resources for periodic beam management or monitoring for the UE.

However, the UE may measure signal quality from not only N CSI-RS resources but also M beamformed SS blocks (with wider coverage). Accordingly, a certain UE may not have an alternative beam among the configured N CSI-RSs but may find an alternative beam, that is, a signal having a specific quality or higher, among the M SS blocks. However, in this case, since the SS block is cell-specific and has periodic properties, it is not suitable to be included in the above-described (aperiodic) beam RS category that should be transmitted UE-specifically as on-demand. Therefore, this case may be considered as a category of the method 1 requiring a follow-up process of transmitting (aperiodic) beam RS (e.g., CSI-RS) to the UE even if there is an alternative SS block.

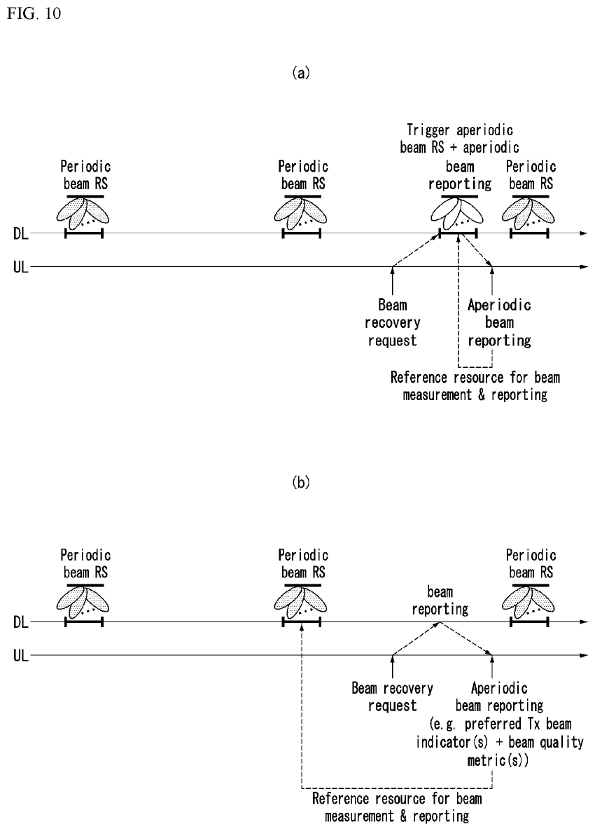

FIG. 10 shows an example of a network operation according to the presence or absence of an alternative beam.

Specifically, FIG. 10A is a diagram schematizing the method 1.

Here, the beam RS trigger and the beam reporting trigger may be independently signaled or jointly signaled.

In an example, the network may trigger a beam RS and beam reporting together using one DCI.

Referring to FIG. 10A, the network transmits a periodic beam RS to the UE through DL.

Thereafter, when the network receives a beam recovery request from the UE, the network triggers the (aperiodic) beam RS and (aperiodic) beam reporting together to the UE (according to the method 1).

Accordingly, the UE performs beam measurement through a reference resource and reports the beam measurement result to the network.

A specific method of determining the reference resource will be described later.

(Method 2)

The method 2 shows a network operation when there is an alternative DL beam pair.

That is, in the method 2, when the network receives a beam recovery request from the UE, the network performs an (aperiodic) beam reporting trigger as shown in FIG. 10B.

FIG. 10B is a diagram schematizing the method 2.

Referring to FIG. 10B, the network transmits a periodic beam RS to the UE through DL.

Thereafter, when the network receives a beam recovery request from the UE, the network triggers (aperiodic) beam reporting to the UE.

Here, in the method 2, unlike the method 1, since the UE knows the alternative DL beam pair, the network does not separately transmit (or do not trigger) the (aperiodic) beam RS to the corresponding UE.

Accordingly, the UE performs beam measurement through the reference resource and reports a beam measurement result to the network.

Here, a preferred Tx beam indicator and a beam quality metric may be transmitted together in the beam reporting process. Details thereof will be described later.

As described above, the method 2 is useful when the UE knows DL Tx beam (or DL beam pair) information that may be replaced from a channel measured through a preset RS because transmission of a beam RS of a network and reception of a beam RS of a UE can be omitted.

Meanwhile, the method 1 described above is useful when there is no alternative beam or the BS cannot know information on the presence or absence of the alternative beam.

In addition, (beam) reporting setting may not be distinguished for the method 1 and the method 2.

That is, in the method 1 and the method 2, beam reporting may configure the same feedback information, have the same time domain behavior (e.g. aperiodic reporting) of the UE, and have the same frequency side granularity.

The same feedback information may include, for example, a preferred DL Tx beam indicator(s) and a beam quality metric(s).

The preferred DL Tx beam indicator may be, for example, a beam ID, a CSI-RS resource indicator (CRI), an RS port index, or the like.

The beam quality metric may be, for example, L1 RSRP, CQI, or the like.

In the beam recovery method, the network may support at least one of the following schemes for the UE through RRC signaling.

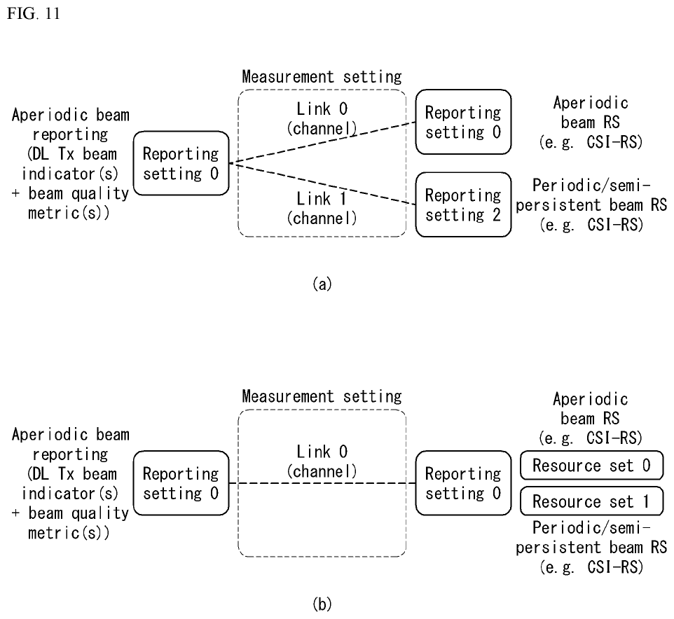

FIG. 11 illustrates an example of a beam-related setting method.

(Setting Method 1)

Referring to FIG. 11A, a reporting setting may include one aperiodic CSI/beam reporting setting, and a resource setting may include one aperiodic beam RS setting (e.g., CSI-RS) and one periodic/semi-persistent beam RS setting.

Here, the plurality of reporting settings may be represented by reporting settings and the like, and the plurality of resource settings may be represented by resource settings or the like.

In addition, the resource setting may include one or more resource sets.

Referring to FIG. 11A, it can be seen that one reporting setting and two resource settings are linked through a link (or channel) in a measurement setting.

(Setting Method 2)

Referring to FIG. 11B, a reporting setting may include one aperiodic CSI/beam reporting setting, a resource setting may include one beam RS setting, and the beam RS setting may include at least two resource sets as follows.
Resource set with aperiodic beam RS(s) (e.g. CSI-RS)
Resource set with periodic/semi-persistent beam RS(s) (e.g. CSI-RS)

In addition, the two settings (reporting setting, resource setting) are connected by one link (or channel) in the measurement setting.

As described above, the setting method 1 is useful when a time-domain behavior (aperiodic, semi-persistent (SP), periodic) is commonly set in units of resource settings.

Also, the setting method 2 may be useful when the time-domain behavior is commonly set in units of resource sets in the resource setting.

Next, a method of providing information on which of the method 1 and the method 2 the UE prefers to or information on whether there is an alternative beam (or a measurement value) from a previously measured RS to a network (or BS) will be described in detail.

The information on which method the UE prefers or the information on whether there is an alternative beam will be referred to as “control information”.

In this case, the control information may be included in a beam recovery request signal or a beam failure reporting signal.

The control information may be indicator or indication information directly indicating the presence or absence of an alternative beam, may be preferred link information associated with a pre-configured aperiodic beam reporting setting (in the case of the setting method 1), preferred resource setting information (in the case of the setting method 1), or preferred resource set information (in the case of the setting method 2).

The control information may be delivered as physical layer control information, such as uplink control information (UCI) in an LTE system to the network or may be delivered in a higher layer message form (e.g. MAC CE).

In particular, the UE may transmit the control information using the same resource (e.g., symbol(s)) as the PRACH.

When the UE uses (or transmits) a signal CDM-ed (code division multiplexed) or FDM-ed (frequency division multiplexed) with the PRACH as a beam recovery request signal, the UE may divide and use a sequence set used in the PRACH according to the presence or absence of an alternative beam.

For example, when a sequence set used in the PRACH is divided and used, a separated root index(es) or cyclic shift values may be used.

Alternatively, when the UE uses the signal CDM-ed or FDM-ed with the PRACH as a beam recovery request signal, the same sequence set as a sequence set used in the PRACH may be used. In this case, however, the PRACH or the beam recovery request signal may be distinguished by applying different time domain/frequency domain orthogonal cover codes (OCCs).

In addition, when the network (or the BS) indicates aperiodic reporting triggering to the UE with a MAC control element (CE) which is a higher layer message and/or downlink control information (DCI) which is a physical layer message, it may include at least one of the following information (1) to (4).

(1) Information on Valid/Invalid Link within Pre-Associated Settings (in the Case of Setting Method 1)
The UE may determine only an RS included in a resource setting indicated by a valid link (or not indicated by an invalid link) among a plurality of resource settings that are pre-associated as a measurement setting, as a reference resource, and performs beam measurement and beam reporting on the beam measurement.

(2) Information on Valid/Invalid Resource Setting within the Pre-Associated Settings (in the Case of Setting Method 2).
The UE determines only RS included in a valid resource setting (or not included in an invalid resource setting) among a plurality of resource settings which are pre-associated as a measurement setting, as a reference resource, and performs beam measurement and beam reporting.

(3) Information on Valid/Invalid Resource Set in Pre-Associated Resource Setting (in the Case of Setting Method 2)
The UE determines only RS included in a valid resource set within a resource setting pre-associated as a measurement setting, as a reference resource, and performs beam measurement and beam reporting.

(4) Reporting Type/Mode Setting Information (Applied to Both Setting Method 1 and Setting Method 2)
The reporting type/mode setting information indicates an indicator or indication information on whether triggering of aperiodic resources and triggering of aperiodic reporting are indicated together or only aperiodic reporting triggering is indicated.

Here, the reporting type or mode when the triggering of the aperiodic resource and the triggering of the aperiodic reporting are indicated together may be expressed as a joint triggering mode or a first mode, and the reporting type or mode when only the aperiodic reporting triggering is indicated may be expressed as a reporting triggering only mode or a second mode.

In the case of the joint triggering mode (or the first mode), the UE determines only aperiodic resource setting/resource set among the resource setting (setting method 1) or resource set (setting method 2) set to RRC, as a reference resource, and performs beam measurement and beam reporting.

That is, the UE disregards the periodic resource/semi-persistent resource established in connection with aperiodic reporting.

In the case of the reporting triggering only mode (or the second mode), the UE determines only the periodic or semi-persistent resource setting/resource set among the resource setting (setting method 1) or resource set (setting method 2) set to RRC, as a reference resource, and performs beam measurement and beam reporting.

That is, the UE disregards the aperiodic resource established in connection with the aperiodic reporting.

In addition, when the UE reports to the BS information on which of the Method 1 and the Method 2 is preferred or information on the presence or absence of an alternative beam (or the presence of a measurement value) from the previously measured RS, the BS may transmit information (confirmation message or ACK/NACK) indicating whether to apply the reporting information of the UE to the UE.

When the reporting information of the UE is transmitted to the BS before indicating the aperiodic reporting triggering of the BS described above, the information indicating whether to apply the reporting information of the UE may be transmitted when indicating the aperiodic reporting triggering of the BS together with the information of (1) to (4) descried above.

When the UE transmits to the BS the information on which of the Method 1 or the Method 2 is preferred or the information on the presence or absence of an alternative beam (or the presence or absence of a measurement value) from a previously measured RS, the BS may transmit information determining reception and application of the corresponding information to the corresponding UE.

For example, when the BS transmits a confirmed (or ACK) message to the UE, this indicates that the information transmitted from the UE is applied in the BS.

Alternatively, when the BS does not transmit the confirmed message or transmits a not-confirmed (or NACK) message to the UE, the BS may request additional transmission of some of the information (1) to (4) descried above from the UE or causes the corresponding UE to retransmit the information on which of the method 1 and the method 2 is preferred or the information on the presence or absence of an alternative beam (or presence or absence of a measurement value).

As described above, the information on which of the method 1 and the method 2 is preferred or the information whether there is an alternative beam (or whether there is a measurement value) may be simply referred to as “control information.”

In addition, the information of (1) to (4) described above may be omitted when the UE (first) reports the information on which of the method 1 and the method 2 is preferred or the information whether there is an alternative beam (or whether there is a measurement value) to the BS.

Next, a method of determining a reference resource for beam measurement and beam reporting will be described.

The UE explicitly or implicitly reports, to the BS, information indicating that there is a measurement value on an alternative beam (or the method 2 is preferred) in a beam recover request signal (or beam failure reporting signal).

Thereafter, when the UE receives an aperiodic beam reporting triggering instruction from the BS (within a specific time period or before a specific timer expires), the UE may determine, as a reference resource, a resource which is activated (or triggered or configured) and measurable before a slot in which a reporting triggering message is received (e.g., periodic RS, activated semi-persistent RS, [symbol] pre-triggered aperiodic RS) among the resources (RSs) included in the resource setting connected to the corresponding aperiodic beam reporting (setting method 1)/resource set (setting method 2), and perform beam measurement and beam reporting may be performed.

That is, the reference resource is determined as a specific resource activated before the slot in which the reporting triggering message is received.

Corresponding contents may be referred to FIG. 10B illustrating the method 2.

In another example, the UE reports, to the BS explicitly or implicitly, information indicating that ii) there is no measurement value on an alternative beam (or the method 1 is preferred) in the beam recovery request signal (or beam failure reporting signal).

Thereafter, when the UE receives an aperiodic beam reporting triggering instruction from the BS (within a specific time or before a specific timer expires), the UE determines, as a reference resource, a resource which is to be activated (or triggered or configured) at the same slot with a slot in which a reporting triggering message is received or at a later time point (e.g., triggered/activated aperiodic RS in later slot(s)) among the resources (RSs) included in the resource setting associated with the corresponding aperiodic beam reporting (setting method 1)/resource set (setting method 2), and perform beam measurement and beam reporting. Corresponding contents may be referred to FIG. 10A illustrating the method 1.

That is, the reference resource is determined as a specific resource which is to be activated in the same slot as the slot in which the reporting triggering message is received or in a slot after the slot in which the reporting triggering message is received.

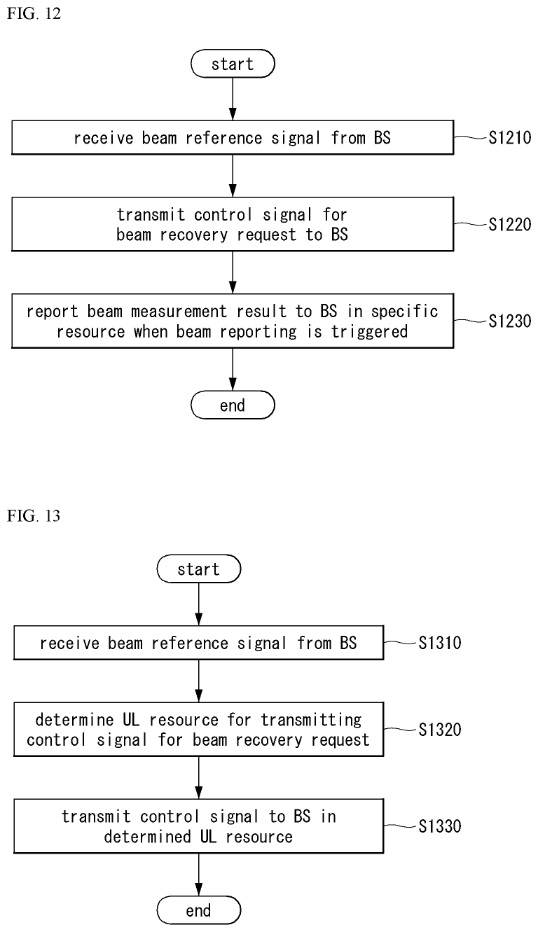

FIG. 12 is a flowchart illustrating an example of a method of performing beam recovery.

First, the UE receives a beam reference signal (BRS) used for beam management from a BS (S1210).

Thereafter, when a beam failure event is detected, the UE transmits a control signal for a beam failure recovery request to the BS (S1220).

The beam failure event may be detected based on the received beam reference signal.

The control signal includes indication information indicating whether an alternative beam exists.

As described above, the alternative beam may refer to a reference signal having a channel quality higher than a specific channel quality among the reference signals set for the beam management.

Subsequently, when beam reporting is triggered, the UE reports a beam measurement result to the BS in a specific resource (S1230).

The control signal may use the same time resource as the physical random access channel (PRACH).

In this case, the control signal may be CDM-ed or FDM-ed in the PRACH and the time resource.

The control signal may be transmitted through a physical uplink control channel (PUCCH).

The control signal may use different time and/or frequency resources, different sequence sets, and/or different uplink control information (UCI) according to the presence or absence of the alternative beam.

In this case, the different sequence sets may be distinguished by a root sequence index or a cyclic shift value.

In addition, the indication information may include information on a preferred link associated with a preset aperiodic beam reporting setting, information on a preferred resource setting associated with a preset aperiodic beam reporting setting, or information on a preferred resource set associated with a preset aperiodic beam reporting setting.

In addition, the UE may receive an indication message indicating triggering of the beam report from the BS.

Here, the beam reporting may be triggered based on the indication message.

The indication message may include at least one of information related to a link which is valid or invalid in settings previously associated with a measurement setting, information related to a resource setting which is valid or invalid in settings previously associated with the measurement setting, information related to a resource set which is valid or invalid in settings previously associated with a measurement setting, or beam reporting mode setting information.

In the measurement setting, one reporting setting and two resource settings may be connected by links, respectively, or one reporting setting and one resource setting may be connected by a link.

The beam report mode setting information may indicate a first mode in which transmission of the aperiodic beam reference signal and aperiodic beam reporting are triggered together or a second mode in which only the aperiodic beam reporting is triggered.

The first mode indicates the joint triggering mode described above, and the second mode indicates the reporting triggering only mode described above.

If the beam report mode setting information is set to the first mode, the specific resource may be a non-periodic resource setting among a resource setting or a resource set to radio resource control (RRC).

In this case, the specific resource may be a resource which is activated to enable beam measurement in the same slot as the slot in which the indication message is received or in a slot after the slot in which the indication message is received.

Alternatively, when the beam report mode setting information is set to the second mode, the specific resource may be a periodic or semi-persistent resource setting or a resource set among the resource setting or resource sets set to RRC.

In this case, the specific resource may be a resource activated to enable beam measurement before the slot in which the indication message is received.

In addition, the UE may receive a response on the report from the BS.

If the response is NACK, the UE may retransmit information including at least one of the indication information or information included in the indication message to the BS.

Hereinafter, a method of performing some or all of beam reporting information together with beam failure reporting differentially according to a type of UL resource performing beam recovery request and/or setting of the UL resource will be described.

The beam recovery request may also be expressed as beam failure reporting.

The beam reporting information may be, for example, preferred DL Tx beam indicator(s), beam quality metric(s) (e.g., L1 RSRP, CQI), and the like.

The preferred DL Tx beam indicator(s) may be, for example, a beam ID, a CSI-RS resource indicator (CRI), an RS port index, an synchronization signal block (SSB) index, a PBCH DMRS index, and the like.

The beam quality metric(s) may be, for example, L1 RSRP, CQI, and the like.

If all the beam reporting information is reported, the aperiodic beam reporting triggering process of the BS and the subsequent beam reporting process of the UE in the setting method (method 2) described above may be omitted, and which may be defined as a “setting method 3”.

In addition, the method of partially reporting the beam report information includes not only a method of reporting only some information but also a method of sending coarse information (or information of lower granularity).

For example, the L1 RSRP transmitted together with beam failure reporting may be configured to include fewer bits than the L1 RSRP transmitted through a subsequent beam reporting process and have a lower quantization level.

Alternatively, the BS may allow the UE to calculate and report a difference value compared to a reporting value reporting (beam failure) at a previous time point, so as to reduce the amount of (beam failure) reporting information.

For example, the UE may transmit differential CQI and differential RSRP together with beam failure reporting.

As described above, as the resource for transmitting a beam recovery request (BRR) in the NR system, both a UL resource (hereinafter, referred to as “UL type 1”) which is CDM-ed or FDM-ed with the PRACH to share a time resource and a UL resource (hereinafter, referred to as “UL type II”) which uses a different time resource from the PRACH may be used.

The UL type I may be configured in a slot type/configuration (e.g., a UL slot or a UL dominant slot) having a relatively large amount of UL resources, similar to the PRACH, and the UL type II may be configured even in a slot having a small amount of UL resources such as the PUCCH.

The UL type I may be PRACH preambles separately configured for the purpose of a beam recovery request (or a beam failure report request).

That is, the PRACH may be used for the beam recovery request, and the PRACH may be contention-free (or non-contention) based PRACH or contention based PRACH.

Here, the contention-free based PRACH resource(s) may be FDM-ed or CDM-ed with other contention-free based PRACH resource(s) (which use the same time or frequency resource but is different in sequence).

For example, the UL type I may be PRACH preambles configured for the purpose of a beam failure report request (BFRQ), and the UL type II may be short/long PUCCH resources.

Also, the beam quality (L1-RSRP) may be reported only when the UE transmits the BFRQ using the UL type II.

In the NR system, the PUCCH is divided into two types (short PUCCH or long PUCCH).

The short PUCCH may include 1 to 2 symbols, may be located at the rearmost portion of the slot, and may transmit uplink control information (UCI) of up to several tens of bits.

In addition, the long PUCCH may include 4 to 12 symbols (or 14 symbols) and transmit up to several hundred bits of UCI.

The UL type II may be transmitted through a PUSCH, a short/long PUCCH, or a separately defined uplink channel.

However, considering a link adaptation problem in a beam failure situation, a UL resource allocation problem, and the like, preferably, the UL type II is transmitted using short PUCCH and/or long PUCCH.

As used herein, “A and/or B” may be interpreted to have the same meaning as “including at least one of A or B.”

Since the UL type I uses the same time resource as the PRACH, it may be assumed that the BS applies Rx beam sweeping (in all directions) to receive the corresponding signal (beam recovery request signal).

Therefore, since a signal is received with good quality only in a time/frequency resource corresponding to a specific beam, the beam recovery request signal is more advantageously designed to have a structure in which less information is repeatedly transmitted.

Therefore, the UL type I may be configured not to include the additional beam reporting information (preferred DL transmission beam indicator, beam quality metric) described above or to include only beam reporting information having a smaller number of bits than the UL type II.

In the case of the UL type I, the setting method 3 (of method 2) is not supported.

In the case of the UL type II, a supported mechanism may be differentially defined or set according to the PUCCH type (short PUCCH or long PUCCH) and a PUCCH resource size (symbol number and/or PRB size).

For example, the beam information that may be transmitted through the long PUCCH may transmit the corresponding L1 RSRP as well as the RS indicator for beam identification, but the beam information that may be transmitted through the short PUCCH may omit the L1 RSRP.

Alternatively, the short PUCCH may be designed or defined not to include the additional beam reporting information.

In addition, supported beam reporting information may be differentially designed according to the number of (short) long/long PUCCH symbols.

In addition, since the short PUCCH tends to be designed for fast ACK/NACK, it may not be desirable for the short PUCCH to be allocated (or set) semi-statically by RRC.

Therefore, it may be more preferable for the UL type II to be transmitted only in the long PUCCH.

In the foregoing descriptions, it is assumed that the UL type I and the UL type II are designed or defined differently (or separately), but the UL type I and the UL type II may also be integrated.

Hereinafter, a method of integrally designing the UL type I and the UL type II will be described.

The BS may set (a plurality of) separate UL resources by RRC according to characteristics of information which can be transmitted together with the beam failure reporting and an amount of the information.

In this case, a specific UL resource set with a period ‘N’ (N is a natural number) may be CDM-ed with the PRACH resource at a period of N×integer multiples and may be TEM-ed with the PRACH resource at other time points.

Here, configuration of information transmitted in the corresponding resource may be configured to be the same regardless of reporting time.

Method for Transmitting Information on Presence or Absence of Alternative Beam

As described above, the feedback information of the implicit/explicit indication of the presence or absence of an alternative beam may also be differentially included in the beam reporting information depending on the type and/or setting of the UL resource or may be transmitted with the beam recovery request.

For example, in the case of the UL type I, since the BS will receive signals in all directions and may support only a small feedback payload, the BS may be reported including the presence or absence of an alternative beam together with the beam recovery request from the UE (supporting the setting method 1 and/or the setting method 2).

In the case of the UL type II, since the BS will receive a signal in a specific direction, it may be defined to be used only when there is an alternative beam, and thus, the BS may allow the UE to report including information for beam identification (and quality information) without transmitting information on the presence or absence of an alternative beam together with the beam recovery request (supporting the setting method 2 and/or the setting method 3).

The beam identification information may be implicitly delivered.

This means that when a UL resource corresponding to a DL resource is configured (for a UE where channel reciprocity is established (or a beam correspondence is established)) (in a form that the UE having good quality of DL RS resource x transmits a signal using a UL resource y, for example), the BS may implicitly obtain DL beam information on the corresponding UE.

That is, in a situation where a plurality of UL resources (e.g., UL type I or UL type II) respectively corresponding to a plurality of DL resources (e.g., synchronization signal block, PBCH DMRS resource, and CSI-RS resources) are mapped and configured, when the UE transmits a signal by selecting one or a plurality of UL resources, the BS may implicitly identify a DL Tx beam corresponding to which DL resource has excellent quality (as an alternative beam).

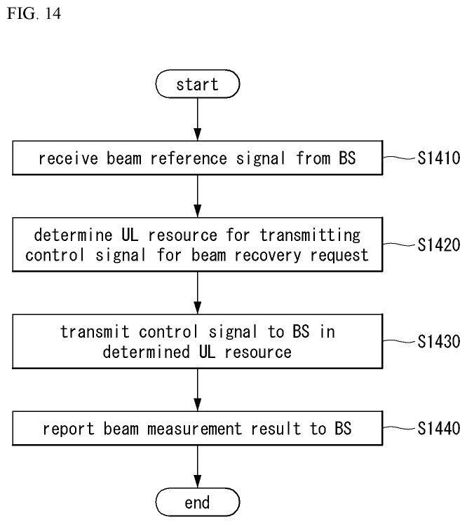

FIGS. 13 and 14 are flowcharts illustrating an example of an operation of a UE performing beam recovery proposed in the present disclosure.

Descriptions of the same part of FIG. 14 as that of FIG. 13 will be referred to FIG. 13, and only differences will be described.

First, a UE receives a beam reference signal used for beam management from a BS (S1310).

Thereafter, when a beam failure event is detected, the UE determines a UL resource for transmitting a control signal related to a beam failure recovery request (S1320).

Here, the UL resource may be the Type 1 resource using the same time resource as the PRACH or the Type 2 resource using a different time resource from the PRACH.

In addition, the Type 1 resource may be FDM-ed and/or CDM-ed with the PRACH.

The Type 2 resource may be a PUCCH resource or a PUSCH resource.

If the Type 2 resource is a PUCCH resource, the PUCCH resource may be at least one of a short PUCCH or a long PUCCH.

Thereafter, the UE transmits the control signal to the BS in the determined UL resource (S1330).

Here, the control signal may include some or all of the information related to beam reporting or may not include the information related to the beam reporting.

If the UL resource is the Type 1 resource, the control signal may include only part of the information related to the beam reporting, and the information related to the beam reporting may include information on the presence or absence of an alternative beam.

The alternative beam may refer to a reference signal having a channel quality higher than a specific channel quality among reference signals set for the beam management.

If the UL resource is the Type 2 resource, the control signal may include all the information related to the beam reporting.

In this case, the information related to the beam reporting may include at least one of beam identification information for beam identification or beam quality information indicating beam quality.

In addition, when the control signal includes a part of the information related to the beam reporting, the UE reports a beam measurement result to the BS in a specific resource (S1440). Here, the reporting on the beam measurement result may be performed when beam reporting is triggered.

Steps S1410 to S1430 of FIG. 14 are the same as steps S1310 to S1330 of FIG. 13.

General Device to which the Present Disclosure May be Applied

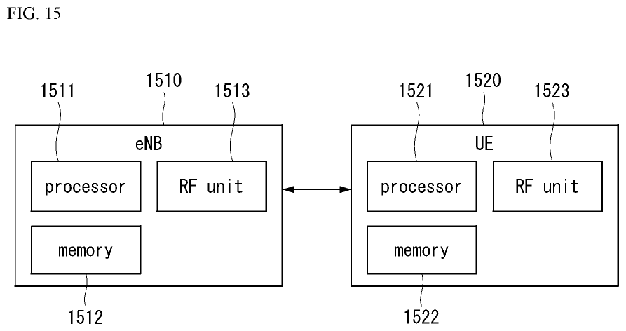

FIG. 15 illustrates a block diagram of a wireless communication device according to an embodiment of the present disclosure.

Referring to FIG. 15, a wireless communication system includes a base station (eNB) (or network) 1510 and a user equipment (UE) 1520.

The BS 1510 includes a processor 1511, a memory 1512, and a communication module 1513.

The processor 1511 implements the functions, processes, and/or methods proposed in FIGS. 1 to 14. Layers of the wired/wireless interface protocols may be implemented by the processor 1511. The memory 1512 is connected to the processor 1511 and stores various information for driving the processor 1511. The communication module 1513 is connected to the processor 1511 and transmits and/or receives a wired/wireless signal.

The communication module 1513 may include a radio frequency (RF) unit for transmitting/receiving a wireless signal.

The UE 1520 includes a processor 1521, a memory 1522, and a communication module (or RF unit) 1523. The processor 1521 implements the functions, processes, and/or methods proposed in FIGS. 1 to 14. Layers of wireless interface protocols may be implemented by the processor 1521. The memory 1522 is connected to the processor 1521 and stores various information for driving the processor 1521. The communication module 1523 is connected to the processor 1521 and transmits and/or receives a wireless signal.

The memory 1512 and 1522 may be present inside or outside the processors 1511 and 1521 and may be connected to the processors 1511 and 1521 by various well-known means.

In addition, the BS 1510 and/or the UE 1520 may have a single antenna or multiple antennas.

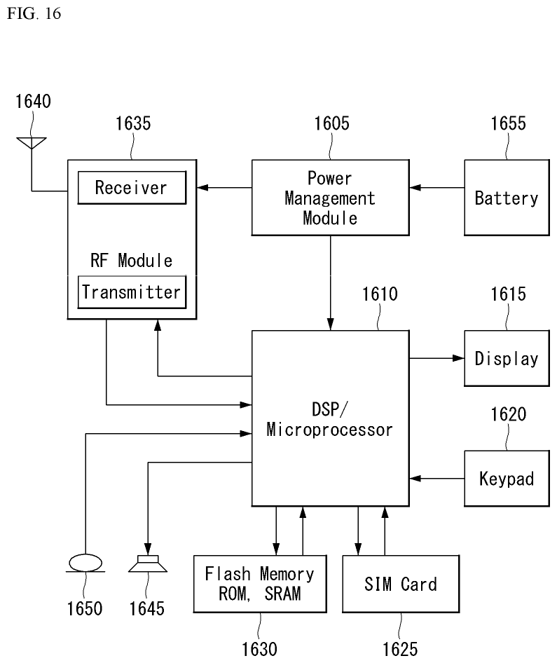

FIG. 16 is a block diagram of a communication device according to an embodiment of the present disclosure.

Specifically, FIG. 16 illustrates the UE of FIG. 15 in more detail.

Referring to FIG. 16, the UE may include a processor (or a digital signal processor (DSP)) 1610, an RF module (or RF unit) 1635, a power management module. 1605, an antenna 1640, a battery 1655, a display 1615, a keypad 1620, a memory 1630, a subscriber identification module (SIM) card 1625 (this component is optional), a speaker 1645, and a microphone 1650. The UE may also include a single antenna or multiple antennas.

The processor 1610 implements the functions, processes, and/or methods proposed in FIGS. 1 to 14. Layers of a wireless air interface protocol may be implemented by the processor.

The memory 1630 is connected to the processor and stores information related to an operation of the processor. The memory may be present inside or outside the processor and may be coupled to the processor by various well known means.

A user may input command information such as a telephone number or the like by pressing (or touching) a button of the keypad 1620 or by voice activation using the microphone 1650. The processor 1610 receives the command information and performs a proper function such as making a phone call with the telephone number or the like. Operational data may be extracted from the SIM card 1625 or the memory 1630. In addition, the processor 1610 may display command information or driving information on the display 1615 for user's knowledge and convenience.

The RF module 1635 is connected to the processor 1610 to transmit and/or receive an RF signal. The processor 1610 transfers command information to the RF module 1635 to transmit a wireless signal configuring voice communication data to initiate communication, for example. The RF module 1635 includes a receiver and a transmitter for receiving and transmitting a wireless signal. The antenna 1640 functions to transmit and receive a wireless signal. When receiving the wireless signal, the RF module 1635 may transfer a signal and convert the signal into a baseband signal for processing by the processor 1610. The processed signal may be converted into audible or readable information output through the speaker 1645.

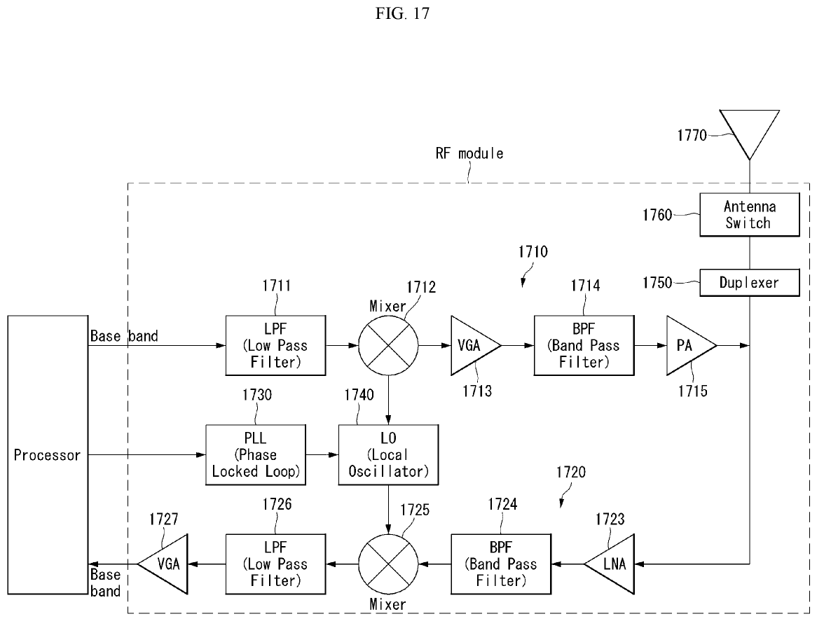

FIG. 17 is a diagram illustrating an example of an RF module of a wireless communication device to which the method proposed in the present disclosure may be applied.

Specifically, FIG. 17 illustrates an example of an RF module that may be implemented in a frequency division duplex (FDD) system.

First, in a transmission path, the processor described in FIGS. 15 and 16 processes data to be transmitted and provides an analog output signal to a transmitter 1710.

In the transmitter 1710, the analog output signal is filtered by a low pass filter (LPF) 1711 to remove images caused by digital-to-analog conversion (ADC), up-converted from a baseband to RF by an up-converter (mixer) 1712, and amplified by a variable gain amplifier (VGA) 1713, and the amplified signal is filtered by a filter 1714, and additionally amplified by a power amplifier (PA) 1715, routed through a duplexer(s) 1750/antenna switch(s) 1760, and transmitted via an antenna 1770.

In addition, in a reception path, the antenna 1770 receives signals from the outside and provides the received signals, and the signals are routed through the antenna switch(s) 1760/duplexers 1750 and provided to the receiver 1720.

In the receiver 1720, the received signals are amplified by a low noise amplifier (LNA) 1723, filtered by a bandpass filter 1724, and down-converted from RF to baseband by a down-converter (mixer, 1725).

The down-converted signal is filtered by a low pass filter (LPF) 1726 and amplified by VGA 1727 to obtain an analog input signal, and the analog input signal is provided to the processor described in FIGS. 15 and 16.

In addition, a local oscillator (LO) generator 1740 generates transmission and reception LO signals and provides to the generated LO signals to each of the up-converter 1712 and the down-converter 1725.

In addition, a phase locked loop (PLL) 1730 receives control information from a processor to generate transmission and reception LO signals at appropriate frequencies and provides control signals to an LO generator 1740.

In addition, the circuits shown in FIG. 17 may be arranged differently from the configuration shown in FIG. 17.

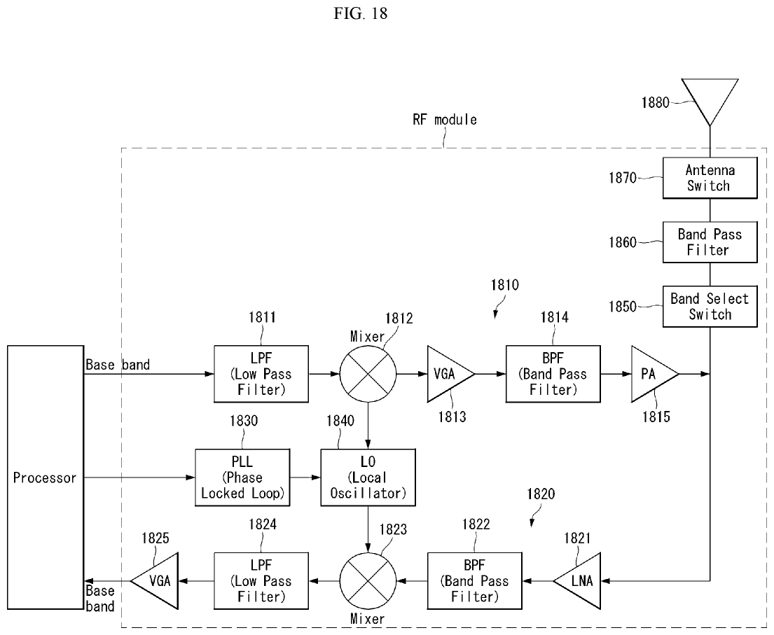

FIG. 18 illustrates another example of an RF module of a wireless communication device to which the method proposed in the present disclosure may be applied.

Specifically, FIG. 18 illustrates an example of an RF module that may be implemented in a time division duplex (TDD) system.

A transmitter 1810 and a receiver 1820 of the RF module in the TDD system have the same structure as the transmitter and receiver of the RF module in the FDD system.

Hereinafter, only a structure of the RF module of the TDD system different from the RF module of the FDD system will be described and the same structure thereof may be referred to the description of FIG. 17.

A signal amplified by a power amplifier (PA) 1815 of the transmitter is routed through a band select switch (1850), a band pass filter (BPF) 1860 and an antenna switch(s) 1870 and transmitted through an antenna 1880.

In addition, in a reception path, the antenna 1880 receives signals from the outside and provides the received signals, and these signals are routed through the BPF 1860 and the band select switch 1850 and provided to receiver 1820.

The aforementioned embodiments are achieved by combination of structural elements and features of the present invention in a predetermined manner. Each of the structural elements or features should be considered selectively unless specified separately. Each of the structural elements or features may be carried out without being combined with other structural elements or features. Also, some structural elements and/or features may be combined with one another to constitute the embodiments of the present invention. The order of operations described in the embodiments of the present invention may be changed. Some structural elements or features of one embodiment may be included in another embodiment, or may be replaced with corresponding structural elements or features of another embodiment. Moreover, it will be apparent that some claims referring to specific claims may be combined with another claims referring to the other claims other than the specific claims to constitute the embodiment or add new claims by means of amendment after the application is filed.

An embodiment of the present invention may be implemented by various means, for example, hardware, firmware, software or a combination of them. In the case of implementations by hardware, an embodiment of the present invention may be implemented using one or more Application-Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, microcontrollers and/or microprocessors.

In the case of implementations by firmware or software, an embodiment of the present invention may be implemented in the form of a module, procedure, or function for performing the aforementioned functions or operations. Software code may be stored in the memory and driven by the processor. The memory may be placed inside or outside the processor, and may exchange data with the processor through a variety of known means.

It is evident to those skilled in the art that the present invention may be materialized in other specific forms without departing from the essential characteristics of the present invention. Accordingly, the detailed description should not be construed as being limitative from all aspects, but should be construed as being illustrative. The scope of the present invention should be determined by reasonable analysis of the attached claims, and all changes within the equivalent range of the present invention are included in the scope of the present invention.

### INDUSTRIAL APPLICABILITY

The example of the beam recovery performing method applied to the 3GPP LTE/LTE-A system and 5G in the wireless communication system of the present disclosure has mainly been described, but the beam recovery performing method may also be applied to various other wireless communication systems.

1. A method for performing beam recovery in a wireless communication system, which is performed by a user equipment (UE), the method comprising:
receiving, from a base station (BS), a beam reference signal used for beam management;
determining an uplink (UL) resource for transmitting a control signal related to a beam failure recovery request if a beam failure event is detected, wherein the UL resource is type 1 indicating a resource related to a physical random access channel (PRACH) set for the beam failure recovery request or type 2 indicating a physical uplink control channel (PUCCH) resource; and
transmitting, to the BS, the control signal in the determined UL resource, wherein the control signal includes some or all of information related to beam reporting.

2. The method of claim 1, wherein
the PUCCH resource is at least one of a short PUCCH or a long PUCCH, when the type 2 resource is a PUCCH resource.

3. The method of claim 2, wherein
the control signal comprises all of the information related to the beam reporting, if the UL resource is the type 2 resource.

4. The method of claim 3, wherein
the information related to the beam reporting comprises at least one of beam identification information for beam identification or beam quality information indicating beam quality.

5. The method of claim 4, wherein
the beam quality is layer 1-reference signal received power (L1-RSRP).

6. The method of claim 1, wherein
the type 1 is frequency division multiplexing (FDM)-ed and/or code division multiplexing (CDM)-ed with the PRACH.

7. The method of claim 6, wherein
the control signal comprises only part of the information related to the beam reporting if the UL resource is type 1 resource.

8. The method of claim 7, wherein
the information related to the beam reporting may include information on the presence or absence of an alternative beam.

9. The method of claim 8, wherein
the alternative beam is a reference signal having a channel quality greater than a specific channel quality among reference signals set for the beam management.

10. The method of claim 1, further comprising:
reporting a beam measurement result to the BS in a specific resource when the control signal includes part of information related to the beam reporting.

11. The method of claim 10, wherein
the beam measurement result is reported if beam reporting is triggered.

12. A user equipment (UE) for performing beam recovery in a wireless communication system, the UE comprising:
a radio frequency (RF) module transmitting and receiving a wireless signal; and
a processor functionally connected to the RF module,
wherein the processor receives, from a base station (BS), a beam reference signal used for beam management and
determines an uplink (UL) resource for transmitting a control signal related to a beam failure recovery request if a beam failure event is detected, wherein the UL resource is type 1 indicating a resource related to a physical random access channel (PRACH) set for the beam failure recovery request or type 2 indicating a physical uplink control channel (PUCCH) resource, and
the processor transmits, to the BS, the control signal in the determined UL resource, wherein the control signal includes some or all of information related to beam reporting.
